(19) United States
(12) Patent Application Publication
(10) Pub. No.: US 2026/0286194 A1
(43) Pub. Date: Sep. 24, 2026

(54) PRESSURE-SENSITIVE ADHESIVE COMPOUND, ADHESIVE TAPE, BONDED ASSEMBLY AND METHOD FOR ELECTRICALLY DEBONDING THE BONDED ASSEMBLY

(71) Applicant: tesa SE, Norderstedt (DE)

(72) Inventors: Caroline Poock, Norderstedt (DE); Johannes Zenner, Hamburg (DE); Sebastian Dietze, Hamburg (DE); Jannik Benecke, Gnutz (DE); Philipp Wegener, Lingen (DE)

(73) Assignee: tesa SE, Norderstedt (DE)

(21) Appl. No.: 19/457,650

(22) Filed: Jan. 23, 2026

(30) Foreign Application Priority Data
Feb. 6, 2025 (DE) 102025104397.3

(51) Int. Cl. C09J 7/38; B32B 43/00; C09J 9/02; C09J 11/06

(52) U.S. Cl. CPC C09J 7/38; B32B 43/006; C09J 9/02; C09J 11/06; C09J 2301/302; C09J 2301/416; C09J 2301/502; C09J 2475/00

(57) ABSTRACT

The invention relates to a pressure-sensitive adhesive compound, a pressure-sensitive adhesive tape, a bonded assembly, a method for electrically debonding the bonded assembly, and the use of the pressure-sensitive adhesive compound.

The pressure-sensitive adhesive compound contains
a) at least one crosslinked polyurethane prepared by crosslinking one or more polyurethane prepolymers, at least one of the polyurethane prepolymers being based on at least one polyol which is selected from the group consisting of polyester polyols, polycarbonate polyols and polyether polyols; and
b) at least one electrolyte, the electrolyte being selected from the group consisting of ionic liquids and metal salts, ionic liquids being particularly preferred.

The invention relates to a pressure-sensitive adhesive compound, an adhesive tape, a bonded assembly, a method for electrically debonding the bonded assembly, and the use of the pressure-sensitive adhesive compound.

In recent times there has been increased interest in “debonding-on-demand” functionalities, this being driven by environmental legislation and end-customer awareness of sustainability and by increasing cost pressures in production. The use scenarios for debonding processes are classified into rework, repair, recycling, and processing aids.

Debonding technologies aim to achieve a cohesive split in the adhesive layer or an adhesive detachment of the adhesive layer from the substrate. Whereas the former necessitates cleaning the substrate before rebonding, in the latter case this is not required.

However, adhesive debonding technologies that guarantee the required high and enduringly reliable bond strength are generally relatively difficult to realize or their application, for example detachment using an infiltrating solvent, is very time-consuming.

For instance, particularly in the rework or repair of electronic devices, such as smartphones and tablet computers, it is predominantly cohesively splitting adhesive bonds that are currently employed, often in the form of pressure-sensitive adhesive tapes, the cohesion of which is reduced by an increase in temperature to such an extent that manual, cohesive separation of the bond can take place. This results in extensive rework to prepare the substrate surface contaminated with adhesive residues for rebonding.

In addition to heat-mediated separation methods, electrical separation methods are being discussed. Thus, for example, EP 3 031 875 B1 discloses lowering the peel adhesion of an acrylate adhesive compound by applying a voltage.

WO 2016/135341 A1 and EP 4 067 401 A1 respectively disclose reactive 1-component and 2-component hotmelt systems containing NCO-functionalized polyurethane and an electrolyte compound, wherein the bonding can be undone again by applying a voltage. However, owing to the associated temperatures for producing the bonding, these hotmelt systems are suitable only for robust substrates.

There is a nevertheless a need to be able to bond even temperature-sensitive substrates with sufficient bond strength for the application.

In addition, the chemical resistance is of high relevance, especially with regard to the application of the pressure-sensitive adhesive in portable electronic devices.

One object underlying the present invention is to provide a pressure-sensitive adhesive compound which has an optimized chemical resistance and also allows a greater lowering of the peel adhesion by application of a voltage. The adhesive compound should therefore be easier to detach electrically and at the same time have a high initial peel adhesion. At the same time, redetachment should be achievable as easily and cleanly as possible.

Another object is to optimize the storage stability of such a pressure-sensitive adhesive compound, especially under hot and humid conditions. The pressure-sensitive adhesive compound should especially still be easy to detach electrically even after storage under hot and humid conditions.

A supplementary object is to provide a corresponding advantageous adhesive tape which has at least one layer of the advantageous pressure-sensitive adhesive compound. The pressure-sensitive adhesive compound or the adhesive tape should also be suitable for bonding temperature-sensitive substrates.

An additional object is to specify a bonded assembly and a method for redetaching the adhesive bond produced by the pressure-sensitive adhesive compound or the adhesive tape.

In addition, it is an object of the invention to provide for a use of the provided adhesive compounds or adhesive tapes for the bonding of two or more substrates.

The above objects are achieved by the subject matter of the invention as defined in the claims.

Preferred configurations of the invention result from the further dependent claims and from the statements hereinafter.

Embodiments that are hereinafter designated as preferred, in particularly preferred embodiments, are combined with features of other embodiments designated as preferred. Very particular preference is therefore given to combinations of two or more of the embodiments designated hereinafter as particularly preferred. Preference is likewise given to embodiments in which a feature of one embodiment designated as preferred to any extent is combined with one or more further features of other embodiments designated as preferred to any extent. The invention thus encompasses combinations of individual features with one another and also with different levels of preference in said combinations. For example, then, the invention encompasses the combination of a first feature designated as “preferred” with a second feature designated as “particularly preferred”. This also includes different levels of preference in the case of subjects referred to in the context of “embodiments”. Features of preferred adhesive tapes, bonded assemblies and also uses and methods arise from the features of preferred pressure-sensitive adhesive compounds. Features of preferred bonded assemblies, uses, and methods also arise from the features of preferred adhesive tapes.

Insofar as hereinafter, for an element, for example for the polyurethane, both specific amounts or fractions of this element and preferred configurations of the element are disclosed, it is the case in particular that the specific amounts or fractions of the preferably configured elements are also disclosed. In addition, it is disclosed that with the corresponding specific total amounts or total fractions of the elements, at least part of the elements can be preferably configured and in particular also that preferably configured elements within the specific total amounts or total fractions may in turn be present in the specific amounts or fractions.

The pressure-sensitive adhesive compound of the invention contains
a) at least one crosslinked polyurethane prepared by crosslinking one or more polyurethane prepolymers, at least one of the polyurethane prepolymers being based on at least one polyol which is selected from the group consisting of polyester polyols, polycarbonate polyols and polyether polyols and is particularly preferably selected from the group consisting of polyester polyols and polycarbonate polyols; and
b) at least one electrolyte, the electrolyte being selected from the group consisting of ionic liquids and metal salts, ionic liquids being particularly preferred.

By virtue of the electrolyte present, it is possible, by applying a voltage, to electrically detach the pressure-sensitive adhesive compound even after bonding.

Surprisingly it has emerged that a pressure-sensitive adhesive compound containing at least one polyurethane and at least one electrolyte can be detached again electrically from bonded substrates by applying a voltage in a simple, clean and fast manner without great force, where the peel adhesion before application of the voltage is not negatively impaired. At the same time, the pressure-sensitive adhesive compound and the bond in the bonded assembly produced using it are resistant to chemicals. In addition, the adhesive compound of the invention shows a surprisingly high storage stability even under hot and humid conditions and can still be readily detached electrically thereafter. The pressure-sensitive adhesive compound is also suitable for bonding temperature-sensitive substrates, moreover.

The pressure-sensitive adhesive compound of the invention is set out in more detail hereinbelow.

As usual, “% by weight” here stands for percent by weight.

The expression “at least one” or the equivalent “one or more” refers, in a manner usual in the sector, to the chemical nature of the entity in question and not to the amount of substance thereof. It is clear to the skilled person that the expression “a polyurethane” therefore refers to a multiplicity of polymer chains. In the context of the present invention, a polyurethane in particular has a molecular weight distribution.

The pressure-sensitive adhesive compound of the invention contains b) at least one electrolyte.

An “electrolyte”, according to the general understanding of those skilled in the art, is understood in the present case as meaning a chemical compound that is dissociated into ions in the solid, liquid or dissolved state and that moves in a directed manner under the influence of an electric field.

The electrolyte is selected from the group consisting of ionic liquids and metal salts, ionic liquids being particularly preferred.

In particular, it is possible by means of one or more ionic liquids as electrolyte to easily redetach the pressure-sensitive adhesive compound or the adhesive tape, without this adversely affecting the adhesive properties of the adhesive tape.

Furthermore, the constituents of ionic liquids are nonvolatile, in particular at room temperature.

Ionic liquids are also comparatively heat-stable, non-flammable and chemically comparatively stable, especially towards volatile organic substances.

Ionic liquids in the context of the present invention are salts which are liquid at 100° C. and preferably at room temperature, i.e. 23° C. Ionic liquids accordingly contain anions and cations. Ionic liquids which are liquid at 100° C. but solid at 23° C. are rendered processible preferably by suitable method steps, such as in particular and for example by dissolution in a solvent. Ionic liquids which are liquid at 23° C. are preferred.

When a voltage is applied, the anions migrate to the anode side and the cations migrate to the cathode side. Without wishing to be limited thereto, it can be mechanistically assumed that this causes a reduction in the peel adhesion of the adhesive compound comprising the ionic liquid to at least one substrate, thereby achieving an adhesive split between the adhesive compound and the at least one substrate.

All ionic liquids are in principle suitable in the context of the present invention.

The ionic liquids used in the context of the present invention comprise at least one anion and at least one cation. It is also conceivable here that the ionic liquid comprises two or more types of anion and/or two or more types of cation. It is also conceivable that two or more different ionic liquids are added to the adhesive compound or that the adhesive compound then comprises two or more different ionic liquids.

Preferably, the anion of the ionic liquid is selected from the group consisting of: hexafluorophosphate (PF₆⁻), bis(trifluoromethylsulfonyl)imide (CF₃SO₂)₂N⁻, TFSI), acetate (CH₃COO⁻), tetrafluoroborate (BF₄⁻), octanoate, tosylate (OTs), trifluoromethanesulfonate (CF₃SO₃⁻, OTf, triflate), benzoate, bis(fluorosulfonyl)imide ((FSO₂)₂N⁻, FSI), dicyanamide (N(CN)₂⁻), ethyl sulfate, hexyl sulfate, perchlorate, methanesulfonate (CH₃SO₃⁻), methyl sulfate (CH₃O—SO₃⁻), acrylate, propionate, methyl carbonate, methyl phosphonate (CH₄O₃P⁻), thiocyanate (SCN⁻), dibutyl phosphate, diethyl phosphate, dodecanoate, bromide (Br⁻), fluoride (F⁻), chloride (Cl⁻), iodide (I⁻), tetrachloroaluminate (AICl₄⁻), tetrachloroferrate (FeCl₄⁻), Al₂Cl₇⁻, NO₃⁻, CF₃COO⁻, CF₃CO₃⁻, (CF₃SO₂)₃C⁻, AsFe⁻, SbFe⁻, CF₃(CF₂)₃SO₃⁻, (CF₃CF₂SO₂)₂N⁻ and CF₃CF₂CF₂COO⁻.

Particularly preferably the anion is selected from hexafluorophosphate (PF₆⁻), bis(trifluoromethylsulfonyl)imide (CF₃SO₂)₂N⁻, TFSI), acetate (CH₃COO⁻), tetrafluoroborate (BF₄⁻), octanoate, tosylate (OTs), trifluoromethanesulfonate (CF₃SO₃⁻, OTf, triflate), benzoate, bis(fluorosulfonyl)imide ((FSO₂)₂N⁻, FSI) and dicyanamide (N(CN)₂⁻).

By application of a voltage, this achieves a particularly high reduction in the peel adhesion and thus particularly good electrical detachability of the pressure-sensitive adhesive compound of the invention or adhesive tape of the invention. In particular, this anion achieves particularly swift (re)detachment and no residues are left behind.

In turn, the anion(s) hexafluorophosphate (PF₆⁻) and/or bis(trifluoromethylsulfonyl)imide (CF₃SO₂)₂N⁻, TFSI) and/or trifluoromethanesulfonate (CF₃SO₃⁻, OTf, triflate) are preferred.

The cation of the ionic liquid is preferably selected from the group consisting of imidazolium-based cations, pyridinium-based cations, pyrrolidinium-based cations, ammonium-based cations, phosphonium-based cations, oxazolium-based cations, guanidinium-based cations and thiazolium-based cations.

Particularly preferably, the cation is selected from the group consisting of imidazolium-based cations.

By application of a voltage, this achieves a particularly high reduction in the peel adhesion and thus particularly good electrical detachability of the adhesive compound of the invention or adhesive tape of the invention. In particular, (re)detachment with this cation is particularly quick and no residues are left.

Very preferably, the cation is selected from the group consisting of 1-ethyl-3-methylimidazolium (EMIM), 1-butyl-3-methylimidazolium (BMIM) and 1-allyl-3-methylimidazolium (AMIM).

Particularly preferably, the electrolyte is selected from the group consisting of the ionic liquids 1-ethyl-3-methylimidazolium bis(trifluoromethylsulfonyl)imide (EMIM-TFSI), 1-allyl-3-methylimidazolium bis(trifluoromethylsulfonyl)imide (AMIM-TFSI), 1-ethyl-3-methylimidazolium triflate (EMIM-OTf), and 1-butyl-3-methylimidazolium hexafluorophosphate (BMIM-PF₆).

By application of a voltage, this achieves a particularly high reduction in the peel adhesion and thus particularly good electrical detachability of the adhesive compound of the invention or adhesive tape of the invention.

In particular, this anion achieves particularly swift (re)detachment and no residues are left behind.

The pressure-sensitive adhesive compound of the invention contains preferably 1.0% to 15% by weight, more preferably 2.5% to 11% by weight, of electrolytes, preferably ionic liquids, based on the total weight of the pressure-sensitive adhesive compound.

With such a preferred or more preferred amount of electrolytes, and of ionic liquids in particular, a comparatively rapid electrical detachment is made possible, without this at the same time having any adverse effect prior to detachment on the adhesion of the adhesive compound to in particular at least one substrate.

The pressure-sensitive adhesive compound of the invention contains a) at least one crosslinked polyurethane prepared by crosslinking one or more polyurethane prepolymers, at least one of the polyurethane prepolymers being based on at least one polyol which is selected from the group consisting of polyester polyols, polycarbonate polyols and polyether polyols. The at least one polyurethane a) represents the base polymer in the adhesive compound of the invention. Thus the at least one polyurethane a) in particular also represents the main constituent of the pressure-sensitive adhesive compound of the invention.

According to preferred embodiments of the invention, the total amount of polyurethane a) in the adhesive compound is 60% to 99% by weight, more preferably 70% to 98% by weight, based on the total weight of the adhesive compound.

In this context it is conceivable according to preferred embodiments that the adhesive compound of the invention is simple in composition and consists of polyurethane a) and electrolyte b). For example, the adhesive compound comprises a) 98% to 99% by weight of one or more polyurethanes and b) 1% to 2% by weight of electrolytes, more particularly ionic liquids.

The skilled person is comprehensively familiar, based on their general art knowledge, with polyurethanes as such, with the urethane group that provides the name and with the underlying chemistry. Thus it is known to the skilled person that polyurethanes are based in particular on the reaction, in particular polyaddition, of at least one hydroxy compound with at least one isocyanate compound in a starting composition.

The at least one hydroxy compound in the context of the present compound is at least one polyol, preferably at least one diol, with a mixture of diol(s) and higher polyols also being encompassed.

The at least one isocyanate compound is in particular at least one polyisocyanate, in particular at least one diisocyanate, with a mixture of diisocyanate(s) and higher polyisocyanates being encompassed here as well.

Formulations such as “wherein at least one of the polyurethane prepolymers is based on at least one polyol” are understood to mean that the respective polyurethane prepolymer can be prepared by reaction, in particular polyaddition, of a starting composition which contains at least one polyol. The concept of being “based” is intended as a linguistic abbreviation of this circumstance and does not mean that the polyol stated in each case is the only compound in the starting composition.

The ratio of the number of hydroxy functionalities to isocyanate functionalities can be used, in particular, to adjust the properties of the polyurethane prepared.

If isocyanate functionalities are used in excess to hydroxy functionalities in the preparation of the polyurethane, an isocyanate-terminated polyurethane is obtained. This is particularly suitable for reacting with atmospheric humidity or curing via it.

If hydroxy functionalities are used in excess to isocyanate functionalities in the preparation of the polyurethane, a hydroxy-terminated polyurethane is obtained.

It is also conceivable that different terminal groups instead of OH and/or NCO groups are present, depending on the reaction regime and the involvement of further substances.

According to preferred embodiments of the invention, the at least one crosslinked polyurethane a) comprises at least one polyurethane which is not isocyanate-terminated or otherwise isocyanate-functionalized, which means that this at least one polyurethane has no free isocyanate groups.

The same applies to the one or more polyurethane prepolymers by the crosslinking of which the at least one polyurethane a) is prepared.

According to preferred embodiments of the invention, the at least one crosslinked polyurethane a) comprises at least one polyurethane which is prepared by crosslinking one or more polyurethane prepolymers, wherein at least one of the polyurethane prepolymers has no free isocyanate groups.

According to preferred embodiments of the invention, all the polyurethanes a) contained in the adhesive compound are not isocyanate-terminated or otherwise isocyanate-functionalized, which means that each of the polyurethanes a) has no free isocyanate groups.

The same applies to the one or more polyurethane prepolymers by the crosslinking of which the at least one polyurethane a) is prepared.

According to preferred embodiments of the invention, the at least one crosslinked polyurethane a) comprises at least one polyurethane which is prepared by crosslinking one or more polyurethane prepolymers, wherein all of the polyurethane prepolymers have no free isocyanate groups.

According to preferred embodiments of the invention, the at least one polyurethane a) of the pressure-sensitive adhesive compound of the invention comprises at least one hydroxy-terminated polyurethane.

According to preferred embodiments of the invention, the at least one polyurethane a) of the pressure-sensitive adhesive compound of the invention comprises at least one hydroxy-terminated polyurethane which is prepared by crosslinking at least one hydroxy-terminated polyurethane prepolymer.

In the event that the pressure-sensitive adhesive compound contains two or more different polyurethanes, then according to preferred embodiments, all the polyurethanes a) present are hydroxy-terminated.

Preferably, here again, all the polyurethane prepolymers by the crosslinking of which the polyurethanes are prepared are hydroxy-terminated.

According to further preferred embodiments, only one of two or more polyurethanes a) is hydroxy-terminated and only one of two or more polyurethane prepolymers is hydroxy-terminated. The one or more other polyurethanes or polyurethane prepolymers carry either NCO groups or alternative end groups, such as blocked NCO groups or (meth)acrylate groups, for example.

According to the invention, the pressure-sensitive adhesive compound contains as polyurethane a) at least one crosslinked polyurethane prepared by crosslinking one or more polyurethane prepolymers, at least one of the polyurethane prepolymers being based on at least one polyol which is selected from the group consisting of polyester polyols, polycarbonate polyols and polyether polyols.

Particularly preferably, the polyol is selected from the group consisting of polyester polyols and polycarbonate polyols.

Very preferably, the polyol is selected from the group consisting of polyester polyols.

The polyols used according to the invention preferably have a weight-average molar mass Mw in the range from 500 g/mol to 5000 g/mol. Preferably, the polyols have a weight-average molar mass of at least 500 g/mol, and more preferably of at least 1000 g/mol, and/or a weight-average molar mass of up to 5000 g/mol and more preferably of up to 3000 g/mol. It is preferred against this background that the polyester polyols, polycarbonate polyols and/or polyether polyols are selected from the group consisting of polyols having a weight-average molar mass in the range of 500 and 5000 g/mol, and more preferably in the range from 1000 to 3000 g/mol.

The polyols used according to the invention preferably have a glass transition temperature in the range of −80° C. and 5° C., and more preferably of −40° C. and −5° C.

According to the invention, the polyurethane(s) a) is or are provided in the pressure-sensitive adhesive compound in that first a polyurethane prepolymer is prepared, which is mixed in further method steps with other substances, such as in particular at least the electrolyte, and the polyurethane prepolymer or the polyurethane prepolymers in the composition is or are subsequently crosslinked.

According to preferred embodiments of the invention, the at least one crosslinked polyurethane a) is prepared by crosslinking a blend of at least two different polyurethane prepolymers a1) and a2), wherein the polyurethane prepolymers a1) and a2) differ from each other with regard to the composition of the polymer chain, wherein at least one of the polyurethane prepolymers is based on a polyester polyol and/or a polycarbonate polyol, with polyester polyol being particularly preferred here as well.

The term “blend” is understood, as is familiar to the skilled person, to be a mixture.

“Polyurethane prepolymers” are copolymers which are prepared from a specific starting composition by polymerization, more precisely by polyaddition. According to the invention, “polyurethane prepolymers” are understood to mean compounds in which a small change in the number of the units forming the macromolecule does not produce any further significant change in properties, so that in accordance with the IUPAC rules, the compounds in question could actually already be referred to as polymers and no longer as oligomers. This is the case at least beyond a weight-average molar mass of 10 000 g/mol. Preferably, therefore, the polyurethane prepolymers have a weight-average molar mass of at least 8000 g/mol, preferably of at least 12 000 g/mol and particularly preferably of at least 20 000 g/mol.

Preferably, the polyurethane prepolymers have a weight-average molar mass of up to 200 000 g/mol, particularly preferably of up to 150 000 g/mol. The polyurethane prepolymers preferably have a glass transition temperature in the range of −80° C. and 5° C., and more preferably of −40° C. and −5° C.

In accordance with the expert understanding and the usual approach in the field of technology, it is conducive to define (pre)polymers via the preparation process and/or the starting materials used for their preparation, since it is almost impossible to conclusively define the corresponding materials in their entirety in any other way.

In line with this usual approach in the field of technology, the preparability is stated above with respect to the starting composition, which comprises, in accordance with the expert understanding, all isolated compounds which are converted in the course of polymerization into structural units of the polyurethane prepolymers. Sometimes a corresponding starting composition for the preparation of copolymers is also referred to as a monomer composition; this term is not used in the context of the present invention, since in particular many of the diols typically used are themselves oligomeric or polymeric compounds on application of a strict interpretation. In accordance with the expert understanding, any other constituents which may be present in the reaction mixture during polymerization but which are not incorporated into the polyurethane prepolymers during polymerization, such as solvents or non-reactive other compounds, are not included in the starting composition.

Polyurethane prepolymers which differ from each other with regard to the composition of the polymer chain are understood to mean that polyols and/or polyisocyanates chemically different from each other were used in the preparation of the polyurethane prepolymers.

According to preferred embodiments, the first polyurethane prepolymer a1) is based on a polyester polyol and/or a polycarbonate polyol and the second polyurethane prepolymer a2) is based on a hydroxy-terminated aliphatic polymer, preferably a polybutadiene polyol, and/or a polyfarnesene polyol and/or a fatty acid-based polyester polyol. The above observations on the weight-average molar mass and the glass transition temperature of the polyols also apply to the polybutadiene polyols, polyfarnesene polyols and fatty acid-based polyester polyols. The polybutadiene polyols, polyfarnesene polyols and fatty acid-based polyester polyols are preferably selected from the group consisting of polyols having a weight-average molar mass in the range of 500 and 5000 g/mol, and more preferably in the range from 1000 to 3000 g/mol.

The stated polyols a1) are also referred to as “polar polyols” within the scope of the present invention, and the stated polyols a2) as “non-polar polyols”.

This further optimizes the chemical resistance of the pressure-sensitive adhesive compound and of the bonded assembly produced.

The polyester polyol of all embodiments is preferably an aromatic or aliphatic polyester polyol.

Particularly preferred is an aromatic polyester polyol.

Diols are preferred here. The polyester polyol of all embodiments is therefore preferably an aromatic or aliphatic polyester diol. Particularly preferred is an aromatic polyester diol.

According to particularly preferred embodiments, the first polyurethane prepolymer a1) is based on a polyester polyol and/or a polycarbonate polyol and the second polyurethane prepolymer a2) on a hydroxy-terminated aliphatic polymer, preferably a polybutadiene polyol.

According to further particularly preferred embodiments, the first polyurethane prepolymer a1) is based on a polyester polyol and the second polyurethane prepolymer a2) on a hydroxy-terminated aliphatic polymer, preferably a polybutadiene polyol.

According to further particularly preferred embodiments, the first polyurethane prepolymer a1) is based on a polycarbonate polyol and the second polyurethane prepolymer a2) on a hydroxy-terminated aliphatic polymer, preferably a polybutadiene polyol.

According to further particularly preferred embodiments, the first polyurethane prepolymer a1) is based on a polyester polyol and a polycarbonate polyol and the second polyurethane prepolymer a2) on a hydroxy-terminated aliphatic polymer, preferably a polybutadiene polyol.

In this embodiment, a prepolymer can first be prepared based on a polyester polyol and a polycarbonate polyol. Alternatively, three different separate prepolymer compositions can also be prepared, of which a first prepolymer composition contains a polyurethane prepolymer based on a polyester polyol, a second prepolymer composition contains a polyurethane prepolymer based on a polycarbonate polyol and a third prepolymer composition contains a polyurethane prepolymer based on a hydroxy-terminated aliphatic polymer, preferably based on a polybutadiene polyol.

In particular, a polybutadiene polyol as a further polyol optimizes the chemical resistance, in particular to polar media such as an isopropanol-water mixture, and the humid-heat stability of the pressure-sensitive adhesive compound in all of the stated embodiments.

However, it has emerged that no advantageous properties are achieved when the pressure-sensitive adhesive compound contains as polyurethane a) a polyurethane which is based exclusively on a polybutadiene polyol.

Preferably, the ratio of polyurethane prepolymers a1) to polyurethane prepolymers a2) is 20 to 95:5 to 80, particularly preferably 30 to 95:5 to 70, preferably 50 to 95:5 to 50, preferably 75 to 95:5 to 25, for example preferably 80:20, with the polyurethane prepolymers a1) and a2) being each listed and defined in the respective embodiments.

The polybutadiene polyol is preferably a polybutadiene diol.

In addition to the respective diols in the starting compositions, higher polyols can also be used to adjust the physicochemical properties. In the estimation of the inventors, however, the resulting branching of the polyurethane prepolymers should be kept as low as possible in order not to adversely affect the pressure-sensitive adhesive properties. If the degree of branching is too high, the adhesive compound produced loses its ability to flow onto the substrate and is then less suitable or no longer suitable at all as a pressure-sensitive adhesive compound.

Preferably, the respective starting composition of the polyurethane prepolymers thus comprises in each case one or more polyol compounds with three or more hydroxy groups in a combined mass fraction of 15% or less, particularly preferably of 10% or less, very preferably of 3% or less, very preferably indeed of 0.5% or less, based on the mass of the starting composition concerned.

EP 4 067 401 A1, on the other hand, discloses hotmelt systems in which the polyurethanes are based to an extent of more than 50% by weight on triols, so that the intermediate compounds are so strongly branched that they are not pressure-sensitive adhesive.

In addition, higher polyisocyanates can also be used to adjust the physicochemical properties in the starting compositions. In the estimation of the inventors, however, the resulting branching of the polyurethane prepolymers should be kept as low as possible in order not to adversely affect the pressure-sensitive adhesive properties. If the degree of branching is too high, the adhesive compound produced loses its ability to flow onto the substrate and is then less suitable or no longer suitable at all as a pressure-sensitive adhesive compound.

It is preferred here that the respective starting composition comprises one or more polyisocyanate compounds having three or more isocyanate groups, in a combined mass fraction of 15% or less, particularly preferably of 10% or less, very preferably of 3% or less, very preferably indeed of 0.5% or less, based in each case on the mass of the starting composition concerned.

Fundamentally, the skilled person is aware of a large number of suitable diisocyanate compounds. In the estimation of the inventors, however, it is preferred that the respective diisocyanate compound for the preparation of the polyurethanes or the polyurethane prepolymers is selected from the group consisting of hexamethylene diisocyanate, 1,6-diisocyanato-2,2,4-trimethylhexane, pentamethylene diisocyanate, (S)-ethyl 2,6-diisocyanatohexanoate, (R)-ethyl 2,6-diisocyanatohexanoate, isophorone diisocyanate, 1,1′-methylenebis(4-isocyanatocyclohexane), 4,4′-methylenebis(phenyl isocyanate), toluene 2,4-diisocyanate, naphthylene 1,5-diisocyanate and meta-tetramethylxylylene diisocyanate.

In the preparation of the pressure-sensitive adhesive compound of the invention, at least one so-called polyurethane prepolymer composition is initially prepared as described, and is then crosslinked to obtain a crosslinked pressure-sensitive adhesive compound.

This prepolymer composition preferably also comprises, in addition to the at least one polyurethane prepolymer, the other components—if present—which are to be included later in the crosslinked pressure-sensitive adhesive compound, such as resins, dyes or other additives, which can be added by the skilled person depending on the intended application. The essential constituent of the prepolymer composition in view of the invention is at least one polyurethane prepolymer.

In the case of a blend of at least two or more different polyurethane prepolymers, preferably two initially separate polyurethane prepolymer compositions are prepared, of which the first is the prepolymer composition of the polyurethane a1) and the second is the prepolymer composition of the polyurethane a2).

These are then mixed with each other.

The preparation of the one or more prepolymer compositions can be carried out in a solvent or solvent-free.

Preferably, the preparation of the one or more prepolymer compositions and thus the preparation of the pressure-sensitive adhesive compound of the invention takes place in a solvent. The solvent is preferably selected from the group consisting of ketones, for example acetone or butanone (MEK=methyl ethyl ketone), esters, for example ethyl acetate, ethers, amides, hydrocarbons, such as mineral spirit 60/90, toluene, halogenated hydrocarbons and mixtures of these solvents.

The solvent is preferably evaporated after the pressure-sensitive adhesive compound has been coated out to form a layer.

The one or more polyurethanes a) present are crosslinked.

The skilled person understands this to mean that the one or more polyurethane prepolymers have been at least partially crosslinked as a result of the crosslinking. In accordance with the expert understanding, this does not exclusively require attainment of the theoretically maximum possible crosslinking in the sense of complete crosslinking of the pressure-sensitive adhesive compound. Rather, any crosslinking that takes place is sufficient if it leads to a technically meaningful and utilizable change in the properties of the prepolymer composition and/or the pressure-sensitive adhesive compound.

The skilled person understands that the terms “crosslinked” and thus the opposite “non-crosslinked” refer to chemical crosslinking, i.e. the covalent connection of individual copolymer strands to each other to form a network, and not to any physical crosslinking of the copolymer chains, for example by looping, phase separation or crystallization, thus meaning that polyurethane prepolymers are regularly meltable. The skilled person understands that a non-crosslinked polyurethane prepolymer does not necessarily have to be linear, but may also have copolymer chains with branches, which may be the case in particular if the starting composition for the manufacture of the polyurethane comprises not only diisocyanates and diols but also higher polyisocyanates and/or polyols. Although the transition from branched copolymer chains to a crosslinked network of the crosslinked pressure-sensitive adhesive compound may seem imprecise in theory, the non-crosslinked state or the crosslinking is relatively easy for the skilled person to determine in practice; the skilled person can determine this, for example, on the basis of the temperature-dependent rheological properties or with simple solubility tests. In crosslinked pressure-sensitive adhesive compounds, indeed, the resulting crosslinked polyurethanes have a greatly increased molecular weight and are therefore generally no longer soluble in organic solvents or no longer meltable, so that an essentially irreversible liquefaction is possible only by decomposition.

Irrespective of the degree of crosslinking, it is in any case possible for the pressure-sensitive adhesive compound of the invention containing the at least one crosslinked polyurethane a) and the pressure-sensitive adhesive tape of the invention to be applied directly to substrates, without a further step of crosslinking taking place, for instance, after or during application. The pressure-sensitive adhesive properties are advantageous at application, and a further method step, which could possibly damage the substrate, such as heating, is not necessary.

The crosslinking of the polyurethane prepolymers can fundamentally be carried out in any manner known to the skilled person, for example via terminal or else in-chain OH and NCO groups. The term “in-chain” here, in contrast to “terminal”, refers to OH and NCO groups which are not terminal but instead are present as substituents on atoms that form the part of the polymer main chain running between the chain end links or form a side chain protruding from the main chain; in the latter case, however, they again do not form the end link of the side chain.

However, it is preferred that the one or more polyurethane prepolymers for the preparation of the crosslinked polyurethane a) are based in each case on the polyaddition of a starting composition which contains at least one diol compound A, wherein the diol compound A has per molecule at least one C—C double bond protruding from the chain extending between the OH groups.

In this case, the fraction of diol compounds A in the starting composition of the respective prepolymer is 15% by weight or less, more preferably 10% by weight or less, very preferably 5% by weight or less, based on the total weight of the starting composition in question.

Preferably in turn, in the respective starting composition for the preparation of the respective polyurethane prepolymer, the at least one diol compound A is present at 3% by weight or less, very preferably at 1% by weight or less, based in each case on the total weight of the starting composition in question.

The crosslinking of the polyurethane prepolymers for the preparation of the crosslinked polyurethane a) takes place via these protruding C—C double bonds.

Preferably, the crosslinking in this method is carried out radically, in particular radically with radiation initiation, particularly preferably radically with UV initiation; unlike in the prior art, in this case it thus takes place not or at least not exclusively, preferably not at all, by the reaction with polyfunctional isocyanates. However, typical polyurethane prepolymers cannot actually be crosslinked radically. This becomes possible only by virtue of the C—C double bonds, which are preferably incorporated into the polyurethane prepolymers by the respective diol compounds. The inventors have recognized that not only is the presence of C—C double bonds protruding from the chain extending between the OH groups necessary, but that diol compounds equipped with such C—C double bonds that are used should preferably be those diols which carry only one, i.e. exactly one, of these C—C double bonds, in order to enable optimal crosslinking and at the same time to allow advantageous properties in the crosslinked adhesive compound, in particular good damping and adhesive properties.

It is therefore particularly preferred that at least one polyurethane a) is based on a polyurethane prepolymer which in turn is based on at least one diol compound A which has per molecule exactly one C—C double bond protruding from the chain extending between the OH groups.

For the purposes of intelligibility and clarity, in the context of the present invention, diol compounds having per molecule at least one C—C double bond protruding from the chain extending between the OH groups are referred to as “diol compounds A”.

The at least one diol compound A should, according to the inventors' estimation, be preferably rather short in configuration, for obtaining particularly advantageous polyurethane prepolymers and advantageous crosslinked pressure-sensitive adhesive compounds. As a result, these diol compounds not only incorporate the double bonds required for crosslinking into the polyurethane prepolymers, but also provide a relatively high density of urethane groups in the polyurethanes. Owing to the high density of structurally comparatively rigid functional groups and the formation of hydrogen bonds, the cohesion of the pressure-sensitive adhesive compound is increased, which benefits the technical adhesive properties.

It is preferred against this background that the at least one diol compound A is selected from the group consisting of diols having 4 to 60, more preferably 5 to 30, particularly preferably 6 to 10, carbon atoms. It is preferred in addition or alternatively that the at least one diol compound A is selected from the group consisting of diols having a molar mass in the range from 70 to 750 g/mol, more preferably in the range from 100 to 500 g/mol, particularly preferably in the range from 140 to 250 g/mol.

Particularly preferably, the at least one diol compound A is selected from the group consisting of (meth)acrylates.

Preferably at least one of the polyurethane prepolymers is therefore based on a diol which carries (meth)acrylate groups and is thus a (meth)acrylate-functionalized diol.

This is the case in a similar way for polyols.

Particularly preferred is therefore a pressure-sensitive adhesive compound of the invention which contains at least one polyurethane a) which is based on the crosslinking of at least one polyurethane prepolymer which is based on at least one (meth)acrylate-functionalized diol.

This is the case in a similar way for polyols.

Crosslinking then takes place as described above via these (meth)acrylate groups of the polyurethane prepolymer chains.

The (meth)acrylate-functionalized diols are preferably selected from the group consisting of dihydroxyalkyl (meth)acrylates.

A preferred diol A is glycerol monomethacrylate (2,3-dihydroxypropyl methacrylate).

The one or more polyurethanes are crosslinked preferably by means of ultraviolet (UV) radiation or by means of electron beam curing (EBC).

For the preparation of the polyurethane prepolymers, it is in the opinion of the inventors in many cases expedient to provide a catalyst. The catalyst is preferably selected from the group consisting of organobismuth compounds, organotin compounds, organozirconium compounds, organozinc compounds, tertiary amine compounds, morphine-containing compounds, iron-containing salts and potassium-containing salts.

According to preferred embodiments, at least one organobismuth compound is used as catalyst.

Preference is thus given also to a pressure-sensitive adhesive compound of the invention which contains at least one catalyst which is preferably selected from the group consisting of organobismuth compounds, organotin compounds, organozirconium compounds, organozinc compounds, tertiary amine compounds, morphine-containing compounds, iron-containing salts and potassium-containing salts, with organobismuth compounds being particularly preferred.

For the crosslinking of the polyurethane prepolymers it is possible advantageously to employ typical initiator systems which are known to the skilled person for radical crosslinking, as also used, for example, in the context of (meth)acrylate-based systems.

In the estimation of the inventors, (UV-)radiation-based curing is particularly advantageous.

Preferably, for this purpose, one or more initiator compounds are selected which are selected from the group consisting of radiation-activated initiators, thermally activated initiators and redox initiators, more preferably selected from the group consisting of thermally activated initiators and radiation-activated initiators, particularly preferably radiation-activated initiators.

Preferably, the one or more initiator compounds are selected from the group consisting of α-hydroxy ketones, α-alkoxy ketones, α-amino-aryl ketones, diaryl ketones, azo compounds, acylphosphine oxides, organic or inorganic peroxides, camphorquinones and camphorquinone derivatives.

According to preferred embodiments, the pressure-sensitive adhesive compound of the invention contains at least one initiator which is preferably selected from the group consisting of thermally activated initiators and radiation-activated initiators, particularly preferably radiation-activated initiators, and in turn is preferably selected from the group consisting of α-hydroxy ketones, α-alkoxy ketones, α-amino-aryl ketones, diaryl ketones, azo compounds, acylphosphine oxides, organic or inorganic peroxides, camphorquinones and camphorquinone derivatives.

Preferably, the at least one initiator is contained in an amount of 0.001% to 5% by weight, particularly preferably from 0.05% to 1% by weight, in the respective prepolymer composition, based on the mass of the polyurethane prepolymers in the respective prepolymer composition.

In the case of EBC crosslinking, an initiator is not necessarily included.

In the case of thermal crosslinking, the inventors have identified temperature ranges with which particularly advantageous results can be achieved during crosslinking. Preferably, the crosslinking of the polyurethane prepolymers in the prepolymer composition or the crosslinking of the at least one prepolymer composition takes place at a temperature in the range from 40 to 300° C., more preferably in the range from 50 to 280° C., particularly preferably in the range from 60 to 150° C.

Alternatively, when using radiation-activated initiators, the crosslinking of the polyurethane prepolymers in the prepolymer composition takes place preferably at a temperature in the range from −10 to 40° C., more preferably in the range from 10 to 30° C., particularly preferably in the range from 20 to 25° C.

According to the inventors' estimation, it may be advantageous if the pressure-sensitive adhesive compound produced also comprises resins, more particularly tackifier resins. According to preferred embodiments of the invention, the pressure-sensitive adhesive compound contains one or more resins and thus at least one resin.

Preferably, the resin is a tackifier resin. Suitable and preferred are for example polymers based on unsaturated C₅ or C₉ monomers; terpene-phenol resins; polyterpene resins based on α-pinene and/or β-pinene and/or δ-limonene; aromatic resins such as coumarone-indene resins or resins based on styrene or α-methylstyrene and also rosin and products obtained therefrom, for example disproportionated, dimerized or esterified resins, for example reaction products with glycol, glycerol or pentaerythritol.

A “tackifier resin”, according to the general understanding of the skilled person, is understood to be an oligomeric or polymeric resin that increases adhesion (peel adhesion) of the adhesive compound compared to an adhesive compound that does not contain any tackifier resin but is otherwise identical.

The at least one resin is preferably a hydrocarbon resin.

The total amount of resins, more particularly tackifier resins, is preferably from 0.5% to 30% by weight, particularly preferably from 1% to 15% by weight, very preferably from 1% to 10% by weight, based on the total weight of the pressure-sensitive adhesive compound.

In the stated ranges for the total amount of resins, the pressure-sensitive adhesive compound has very good peel adhesion forces and yet still has electrical redetachability and is optimized for certain applications in terms of chemical resistance, with the adhesive compound, in terms of the conflict of objectives between peel adhesion, chemical resistance and redetachability, being further optimized accordingly in the quantity ranges resulting from the selection of the lower and upper limits of higher levels of preference.

According to further preferred embodiments, the pressure-sensitive adhesive compound of the invention contains no resin.

According to further preferred embodiments of the invention, protective agents are included as additives. These include primary and secondary ageing inhibitors, light stabilizers and UV protectants, and flame retardants.

In addition, however, the adhesive compound may also contain dyes and pigments. The adhesive compound layer may accordingly be coloured any desired colour or may be white, grey, or black. Further additives of this kind, or others, that can typically be utilized are:
primary antioxidants, for example sterically hindered phenols, preferably in a proportion of 0.2% to 1% by weight,
secondary antioxidants, for example phosphites or thioethers, preferably in a proportion of 0.2% to 1% by weight,
light stabilizers, for example UV absorbers or sterically hindered amines, preferably in a proportion of 0.2% to 1% by weight,
processing aids, preferably with a proportion of 0.2 to 1 part by weight based on 100% by weight,
compatibilizers.

Where the adhesive compound comes into contact with a layer from which so-called rubber toxins, such as copper, manganese(II), iron(II), cobalt or nickel ions, can potentially be released, it is advantageous to add thereto at least one type of metal deactivator, also termed a metal scavenger. Specific examples thereof are ADK-Stab CDA-1, CDA-1H, CDA-6, and CDA-10 and also ADK-Stab ZS-27 or ZS-90 from Adeka, Hostanox OSP1 from Clariant, Naugard XL-1 from SI Group and Irganox MD-1024 from BASF. Typical usage quantities are up to 0.5% by weight.

According to further preferred embodiments, the pressure-sensitive adhesive compound of the invention has an ionic conductivity (determined by the method stated below) of 0.1 μS/m to 8.0 μS/m, and preferably of 1.0 μS/m to 4.0 μS/m.

The adhesive compound of the invention is a pressure-sensitive adhesive compound.

A pressure-sensitive adhesive compound is in the present case understood as meaning, as is generally usual, a substance that—particularly at room temperature—is durably tacky and adhesive. Characteristic of a pressure-sensitive adhesive compound is that it can be applied by pressure to a substrate and remains stuck there, the pressure to be applied and the duration of exposure to this pressure not being defined in more detail. In some cases, depending on the exact nature of the pressure-sensitive adhesive compound, the temperature, and the humidity, and on the substrate, the effect of a short-lived, minimal pressure that does not go beyond light contact for a brief moment is sufficient to achieve the adhesion effect; in other cases a more lengthy exposure to a high pressure may also be necessary.

Pressure-sensitive adhesive compounds have particular, characteristic viscoelastic properties that result in durable stickiness and adhesive capability. It is a characteristic feature thereof that, when they are mechanically deformed, the result is both viscous flow processes and the development of elastic resilience forces. The two processes are in a certain relation with one another that depends not just on the exact composition, the structure, and the degree of crosslinking of the pressure-sensitive adhesive compound, but also on the rapidity and duration of the deformation and on the temperature.

The viscous flow component is necessary for achievement of adhesion. Only the viscous components, brought about by macromolecules having relatively high mobility, allow good wetting and good flow onto the substrate to be bonded. A high proportion of viscous flow leads to high pressure-sensitive adhesiveness (also referred to as tack or surface stickiness) and hence often also to a high strength of adhesion. Highly crosslinked systems, or polymers that are crystalline or solidify in vitreous form, generally have at least only low pressure-sensitive adhesion, if any, for lack of free-flowing components.

The one or more crosslinked polyurethanes a) contained are thus particularly preferably prepared by crosslinking of one or more polyurethane prepolymers, wherein the polyurethane prepolymers are all based on amorphous or semi-crystalline polyols. Conversely, the starting compositions for the preparation of the polyurethane prepolymers preferably contain no crystalline polyols.

In addition, therefore, the polyurethane prepolymers are also preferably amorphous or semi-crystalline. This applies to all embodiments.

The elastic resilience force components are needed for achievement of cohesion. They are brought about, for example, by very long-chain and entangled macromolecules that are crosslinked physically or chemically, and enable transmission of the forces that attack an adhesive bond. They have the effect that an adhesive bond can withstand a sustained stress acting thereon, for example in the form of a sustained shear stress, to a sufficient degree over a prolonged period of time.

For the more precise description and quantification of the extent of elastic and viscous components and of the relation of the components to one another, the variables of storage modulus (G′) and loss modulus (G″), which can be determined by means of dynamic mechanical analysis (DMA, according to DIN EN ISO 6721-1:2019), can be employed. G′ is a measure of the elastic component and G″ a measure of the viscous component of a substance. Both parameters are dependent on deformation frequency and temperature.

The parameters can be determined with the aid of a rheometer. The material under examination is subjected here to a sinusoidally oscillating shear stress, for example in a plate-plate arrangement. In the case of shear stress-controlled devices, deformation as a function of time and the time delay of this deformation are measured with respect to the onset of shear stress. This time delay is referred to as the phase angle δ.

The storage modulus G is defined as follows:

$${G}^{′} = ( τ / γ ) \cdot cos ( δ ) ( τ = shear stress , γ = deformation , δ = phase angle = phase shift between shear stress vector and deformation vector ) .$$

The definition of the loss modulus G″ is:

$${G}^{′′} = ( τ / γ ) \cdot sin ( δ ) ( τ = shear stress , γ = deformation , δ = phase angle = phase shift between shear stress vector and deformation vector ) .$$

A substance is generally considered to be pressure-sensitive adhesive and is defined as pressure-sensitive adhesive for the purposes of the invention if at room temperature, here by definition at 23° C., in the deformation frequency range from 10⁰ to 10¹ rad/sec, G′ is at least partly in the range from 10³ to 10⁷ Pa and if G″ is also at least partly in this range. “Partly” means that at least one portion of the G′ curve is within the window spanned by the deformation frequency range from inclusively 10⁰ to inclusively 10¹ rad/sec (abscissa) and the range of the G′ values from inclusively 10³ to inclusively 10⁷ Pa (ordinate). For G″, this applies mutatis mutandis.

Preferably, the pressure-sensitive adhesive compound in the deformation frequency range from 10⁰ to 10¹ rad/sec at 23° C. has a storage modulus G′ and a loss modulus G″ in the range from 10³ to 10⁷ Pa, determined according to DIN EN ISO 6721-1:2019.

To achieve the viscoelastic properties, the starting compounds, more particularly the oligomers or monomers on which the polymers underlying the pressure-sensitive adhesive compound are based, and any further components present in the pressure-sensitive adhesive compound are chosen in particular such that the pressure-sensitive adhesive compound has a glass transition temperature (according to DIN 53765:1994-03) below the use temperature (i.e. typically below room temperature (23° C.)). By means of suitable cohesion-enhancing measures, for example crosslinking reactions (formation of bridging linkages between the macromolecules), it is possible to enlarge and/or to shift the temperature range in which a polymer composition has pressure-sensitive adhesive properties. The range of application of the pressure-sensitive adhesive compounds can thus be optimized via a setting between flowability and cohesion of the compound.

In particular, the pressure-sensitive adhesive compound has a glass transition temperature of ≤23° C., determined in accordance with DIN 53765:1994-03.

In contrast to pressure-sensitive adhesive compounds, hotmelt adhesives, for example those based on polyamides, polyurethanes or modified polyethylenes, display no stickiness at room temperature (23° C.), as well as in hotmelt adhesive compositions too.

The present invention also provides an adhesive tape comprising at least one adhesive compound layer D of at least one pressure-sensitive adhesive compound of the invention.

The adhesive tape of the invention is preferably a double-sided adhesive tape. For the sake of simplicity, the adhesive tape of the invention is referred to in the context of the present invention as “adhesive tape” in the double-sided embodiments too.

The present invention relates to an adhesive tape, which may be present in any desired finished form but with preference given to rolls of adhesive tape. The adhesive tape, particularly in elongate sheet form, can be produced either in the form of a roll, i.e. rolled up on itself in the form of an Archimedean spiral, or as adhesive strips, as obtained for example in the form of blanks or die cuts.

The adhesive tape of the invention is in particular present in elongate sheet form. An elongate sheet means an object, the length of which (extent in x direction) is many times greater than its width (extent in y direction), the width remaining approximately and preferably exactly the same over the entire length.

The general expression “adhesive tape”, and synonymously “adhesive strip”, encompasses for the purposes of this invention all sheetlike structures, such as films or film portions extended in two dimensions, tapes having extended length and limited width, tape portions and the like, and lastly also die cuts or labels.

In addition to the longitudinal extent (x direction) and lateral extent (y direction), the adhesive tape also has a thickness (z direction) running perpendicular to the two extents, the lateral extent and longitudinal extent being many times greater than the thickness. The thickness is as similar as possible, preferably exactly the same within tolerances, over the entire areal extent of the adhesive tapes determined by their length and width.

The statements apply by analogy to the carrier layer(s) that form(s) a layer in the x and y direction as an element of the adhesive tape according to some preferred embodiments.

It is understood that the individual layers are arranged on top of one another along the z direction.

The present invention further provides a bonded assembly comprising at least layers as follows:
a first substrate A; and
a second substrate B; and
an adhesive tape of the invention, which is arranged between the substrate A and the substrate B and bonds the substrates A and B to each other.

In particular, either the substrate A and the substrate B, or at least one of the substrates and the adhesive tape, or none of the substrates and the adhesive tape, are/is of electrically conductive configuration at two different points.

The present invention also provides a method for electrically debonding the assembly according to the invention, comprising at least method steps as follows:
i.) applying a voltage at two different points of the assembly, the voltage being preferably 1 to 50 V.

The voltage is applied in step i.) of the method according to the invention for electrical debonding of the assembly.

The voltage is in particular a DC voltage.

The voltage is preferably 2 to 50 V.

According to preferred embodiments of the invention, the voltage is 3 to 12 V. Such a voltage can in particular be applied by using a battery located in the immediate vicinity of the bond, such as, in particular and for example, in a mobile phone, tablet, etc., or by adding a battery from outside.

According to further preferred embodiments of the invention, the voltage is 12 to 50 V. This comparatively high voltage allows redetachment to take place particularly swiftly; the voltage in this case need only be applied for a few seconds.

Depending on the chosen voltage in particular, the duration of application of the voltage in step i.) can be from a few seconds, more particularly 2 seconds, up to 900 seconds, preferably up to 600 seconds.

It is of course also conceivable for the voltage to be applied for a period of time longer than 900 seconds, particularly if the voltage is relatively low.

The method of the invention for electrically debonding the assembly of the invention allows the substrates A and B to be debonded from one another in a swift and easy manner without too much force being required.

According to particularly preferred embodiments of the invention, the voltage is 3 to 12 V and is applied for 10 to 120 seconds; more particularly preferably, the voltage is 8 to 12 V, for example 9 V, and is applied for 30 to 90 seconds, for example 60 seconds.

If the layers do not separate from one another without further action after applying the voltage, the method of the invention comprises at least the following further method step:
ii.) applying force to the adhesive compound layer D and/or to substrate A and/or to substrate B, such that the distance between substrates A and B is increased.

The force that may still be required according to step ii.) is significantly lower than the strength of adhesion prior to applying the voltage according to step i.).

The application of the voltage according to step i.) takes place at two different electrically conductive points of the bonded assembly of the invention. The points at which the voltage is advantageously applied depend on the construction of the adhesive tape and of the bonded assembly and thus on the nature of the individual layers and substrates A and B bonded together.

Some preferred embodiments are set out hereinbelow.

According to preferred embodiments, the adhesive tape is an adhesive transfer tape and consists of the adhesive compound layer D.

In a bonded assembly comprising two substrates A and B, such an adhesive tape can advantageously be electrically debonded again by virtue of the fact that both substrates A and B are electrically conductive. For this purpose, a voltage is then applied to the substrates A and B, so that the peel adhesion decreases. Without wishing to be bound to a particular theory, the inventors assume the following mechanism: Applying voltage results in a migration of the ions of the ionic liquids, more particularly a separation of the anions and cations of the ionic liquids, in the adhesive compound layer D. This results in the adhesion of the adhesive compound layer D to the substrate A and/or to the substrate B being greatly reduced and in the debonding of these layers from one another. In particular, the adhesive cleavage takes place with respect to the substrate to which the negative pole has been applied.

According to preferred embodiments of the present invention, the bonded assembly thus comprises the following layers:
a first substrate A that is electrically conductive; and
a second substrate B that is electrically conductive; and
an adhesive tape of the invention that consists of the adhesive compound layer D and is arranged between the substrate A and the substrate B and bonds the substrates A and B together.

According to further preferred embodiments, the adhesive tape additionally to the first adhesive compound layer D comprises at least the following layers:
at least one electrically conductive carrier layer T and
optionally a second adhesive compound layer C, which is arranged on the side of the carrier layer T that is opposite the adhesive compound layer D.

Such an adhesive tape can be adapted to a variety of different substrates as a single-sided adhesive tape (if no further adhesive compound is present) or as a double-sided adhesive tape via the second adhesive compound layer C. Preferred is the double-sided embodiment, in which a second adhesive compound layer C is arranged on the side of the carrier layer T that is opposite the adhesive compound layer D.

The substrates can in principle be the same substrates as those in the above embodiments in which the adhesive tape is an adhesive transfer tape.

However, an adhesive tape of this kind can in particular and advantageously also be used in order to later debond substrates A and B from one another when only one is electrically conductive, for example substrate A.

According to preferred embodiments, either xi.) only the carrier layer T or xii.) the carrier layer T and the second adhesive compound layer C are designed to be electrically conductive.

This means that a voltage can be applied to xi.) the electrically conductive carrier layer or xii.) to the second adhesive compound layer C and to the conductive substrate A.

The adhesive tape is initially advantageously bonded as a double-sided adhesive tape such that the electrically debondable adhesive compound layer D is attached to the conductive substrate A and the second adhesive compound layer to the substrate B, which can be conductive, but does not need to be.

The applying of the voltage results in significant lowering of the adhesion of the adhesive compound layer D to the substrate A and in debonding of these layers from one another.

According to preferred embodiments of the invention, xi.) only the carrier layer is electrically conductive. A voltage can in particular and preferably be applied particularly readily thereto when the carrier layer protrudes laterally over at least one of the adhesive compound layers.

According to further preferred embodiments of the invention, xii.) the carrier layer and the second adhesive compound layer C are electrically conductive. A construction of this kind has the advantage that the voltage can be applied to the adhesive compound layer C. A lateral overhang of the carrier layer is not necessary. The adhesive tape can therefore be produced in a simple manner, particularly since layers D, T and C can be die-cut together.

Preferably, the adhesive tape according to the embodiments described above consists of the three layers D, T, and C. This is also referred to in the context of the present application as a three-layer composite D-T-C.

According to preferred embodiments of the present invention, the bonded assembly thus comprises the following layers:
a first substrate A that is electrically conductive; and
a second substrate B; and
an adhesive tape of the invention that consists of the three-layer composite D-T-C and bonds the substrates A and B together such that the adhesive compound layer D is attached to the conductive substrate A.

According to further preferred embodiments, the adhesive tape additionally to the first adhesive compound layer D comprises at least the following layers:
a second adhesive compound layer C; and
at least a first electrically conductive carrier layer T that is arranged between layers D and C; and
at least one second electrically conductive carrier layer T′ that is arranged on the surface of the adhesive compound layer D on the opposite side to the first electrically conductive carrier layer T; and
a third adhesive compound layer C′ that is arranged on the surface of the second electrically conductive carrier layer T′ on the opposite side to the first adhesive compound layer D.

An adhesive tape of this kind has at least the layer construction C-T-D-T′-C′ and, as a double-sided adhesive tape, can be adapted to a variety of different substrates via the adhesive compound layers C and C′.

These can in principle be the same substrates as those in the above embodiments in which the adhesive tape is an adhesive transfer tape or has the three-layer construction D-T-C.

However, an adhesive tape of this kind can in particular and advantageously also be used in order to later debond substrates A and B from one another when neither is electrically conductive.

According to preferred embodiments, either xi.) only the carrier layers T and T′ or xii.) the carrier layers T and T′ and the second adhesive compound layer C and/or the third adhesive compound layer C′ are designed to be electrically conductive.

This means that a voltage can be applied to xi.) both electrically conductive carrier layers or xii.) to at least one of the adhesive compound layers C and C′ and to one of the carrier layers or to the other adhesive compound layer.

Analogously to the above embodiments, it is assumed that by applying of the voltage, the adhesion of the adhesive compound layer D to the electrically conductive carrier layers T and T′ is greatly reduced and thus debonding of these layers from each other takes place.

According to preferred embodiments of the invention, xi.) only the carrier layers T and T′ are electrically conductive. A voltage can in particular and preferably be applied particularly readily thereto when the carrier layers T and T′ protrude laterally over at least one of the respectively adjacent adhesive compound layers.

According to further preferred embodiments of the invention, xii.) the carrier layers T and T′ and the second and third adhesive compound layer C and C′ are electrically conductive. A construction of this kind has the advantage that the voltage can be applied to the adhesive compound layers C and C′. A lateral overhang of the carrier layers T and T′ is not necessary.

The adhesive tape can therefore be produced in a simple manner, particularly since layers C, T, D, T′, and C′ can be die-cut together.

Preferably, the adhesive tape according to the embodiments described above consists of the five layers C, T, D, T′, and C′. This is also referred to in the context of the present application as a five-layer composite C-T-D-T′-C′.

According to preferred embodiments of the present invention, the bonded assembly thus comprises the following layers:
a first substrate A; and
a second substrate B; and
an adhesive tape of the invention that consists of the five-layer composite C-T-D-T′-C′ and bonds the substrates A and B to each other.

The electrically conductive substrate in all embodiments may be for example a metal casing of a mobile phone.

In all embodiments, the electrically non-conductive substrate may in particular be a casing made of a non-conductive material, such as plastic, or a battery or other non-electrically conductive components, for example speakers.

The present invention further provides for the use of the pressure-sensitive adhesive compound of the invention or of the adhesive tape of the invention or of the bonded assembly of the invention in electronic devices, motor vehicles, medical devices and dental devices and in the DIY sector and in the household.

The carrier layers T or T and T′ in all the abovementioned embodiments are electrically conductive.

These layers are set out further in the text below. For the sake of simplicity, the term “electrically conductive carrier layer” or else just “carrier layer” is used. Depending on which one of the above embodiments, this refers to the carrier layer T or the carrier layers T and T′. The carrier layers T and T′ are independent of one another and can be identical or different from one another.

Preferably, the electrically conductive carrier layer comprises at least one metal.

In preferred embodiments of the invention, the metal is selected from the group consisting of copper, nickel, zinc, tin, silver, gold, aluminium, iron, chromium, and alloys of said metals. Very preferably, the metal is selected from the group consisting of aluminium, tin, copper, nickel, chromium-nickel and nickel-iron. Aluminium or tin are very preferred.

Preferably, the electrically conductive carrier layer has a layer thickness, measured in the z direction, i.e. parallel to the stacking direction of the layer arrangement, of 10 nm (nanometres) to 50 μm (micrometres).

According to preferred embodiments of the invention, the electrically conductive carrier layer includes a) at least one metal foil, preferably an aluminium foil or nickel-iron foil, and/or b) at least one electrically conductive textile including at least one metal, preferably selected from the group consisting of copper and nickel, and/or c) one or more plies of at least one metal applied, preferably selected from the group consisting of copper, tin and aluminium, and/or d) at least one metal mesh and/or e) a metallized foil and hence a foil coated with metal, where the metal is preferably selected from the group consisting of aluminium, zinc, chromium-nickel and nickel-iron.

In principle, it is also conceivable here for the layer T to include a combination of two or more of the above options.

Metal foils, for example and with preference aluminium foils or nickel-iron foils, are known to the skilled person.

The metal foil, for example and preferably the aluminium foil, preferably has a layer thickness, measured in the z direction, i.e. parallel to the stacking direction of the layer arrangement, of from 5 to 50 μm, more preferably from 10 to 30 μm.

Electrically conductive textiles are known to the skilled person, in particular by the expression “conductive mesh”. This is a textile fabric, for example one made of PET (polyethylene terephthalate), that is coated with a metal, for example with copper and/or nickel, this being how the electrical conductivity of the fabric is produced.

Those skilled in the art are likewise aware that metals can undergo direct vapour deposition as a monolayer or multilayer onto surfaces such as in this case the surface of an adhesive compound layer.

In the context of the present invention, the electrically conductive carrier layer can be provided by vapour deposition of metal onto the adhesive compound layer D or the adhesive compound layer C or the adhesive compound layer C′.

In the case of metal applied as a carrier layer, it is preferable in advantageous embodiments that this carrier layer protrudes laterally in at least one direction of extension of the layer plane over just one adjacent adhesive compound layer, the respective other adhesive compound layer serving as a mechanical support for this metal layer. The metal layer in this case has no actual carrier function. Instead, the other adhesive compound layer serves as carrier for the metal layer. For the sake of simplicity, the term carrier layer is retained for the metal layer in these embodiments too. Preferably, the layer thickness of the layer T is in this case greater than or equal to 10 nm (nanometres), preferably 50 to 200 nm.

However, it is also conceivable and preferable that none of the layers projects beyond any other layer. This allows the composite of the layers to be easily processed collectively, in particular punched or otherwise converted to the desired shape. It is conceivable and preferable here too that two electrically conductive substrates A and B are bonded and the voltage is applied to these substrates.

In addition, those skilled in the art are familiar with metal grids of varying dimensions. Metal grids having suitable layer thicknesses can be produced for example through a laid scrim of appropriately fine metal threads or by die-cutting at least one foil of appropriate layer thickness.

In the case of a metal-coated film, an electrically non-conductive film in particular is coated with metal in order to make it electrically conductive. The metal is preferably selected from the group consisting of copper, nickel, zinc, tin, silver, gold, aluminium, iron, chromium and alloys of these metals, with aluminium, tin, chromium-nickel and nickel-iron being particularly preferred. The film material can in principle be selected from all materials capable of undergoing vapour deposition with metal and of being used as a carrier film in adhesive tapes, for which polymers in particular are suitable. The material is selected in particular from polyesters and polyolefins, a mixture of more than one material also being conceivable.

Particularly preferred polyesters are polyethylene terephthalate (PET) and polyethylene naphthalate (PEN). Particularly preferred polyolefins are polypropylene (PP) and polyethylene (PE). In preferred embodiments, the film material is selected from the group consisting of PET, PEN, PE and PP.

Preferably, it is a PET (polyethylene terephthalate) film. A film of this kind is dimensionally stable and therefore easy to process without significant stretching or tearing. This makes it possible to durably apply a homogeneous and gapless metal layer, with the result that the electrical conductivity, particularly in the z direction, is durably guaranteed across the entire film.

The film can be coated with metal in any manner known to the skilled person.

In the embodiments in which at least one electrically conductive carrier layer T or at least two electrically conductive carrier layers T and T′ are present, it is preferable that this at least one adjacent adhesive compound layer protrudes laterally in at least one direction of extension of the layer plane and thus includes a lateral overhang. A voltage can then be applied to this lateral overhang in a simple manner.

In the case of the five-layer composite, the lateral overhangs of the electrically conductive carrier layers T and T′ are in advantageous embodiments arranged spatially apart from one another. This makes it easier to apply a voltage to said two overhangs.

In the case of metal deposited by vapour deposition as a carrier layer, it is preferable that this carrier layer protrudes laterally in at least one direction of extension of the layer plane over just one adjacent adhesive compound layer, the respective other adhesive compound layer serving as a mechanical support for this metal layer. The metal layer in this case has no actual carrier function. Instead, the other adhesive compound layer serves as carrier for the metal layer. For the sake of simplicity, the term carrier layer is retained for the metal layer in these embodiments too. Preferably, the layer thickness of the layer T is in this case greater than or equal to 10 nm (nanometres), preferably 50 to 200 nm.

In further advantageous embodiments, it is also conceivable and preferable that none of the carrier layers projects beyond any other layer, in particular adjacent adhesive compound layer.

This allows the composite of the layers to be easily processed collectively, in particular punched or otherwise converted to the desired shape.

Such a structure thus has the advantage of simple producibility and, in addition, the possibility of adjusting the stability of the adhesive tape via the carrier layer(s). It is conceivable and preferable here too that two electrically conductive substrates A and B are bonded and the voltage is applied to these substrates. In this case, the electrically conductive carrier layer is a continuously conductive layer in the z direction, in particular and preferably a metal foil according to option a) above.

The expression “protrude laterally” is understood in the context of the present invention as meaning any kind of lateral overhang of the layer or layers concerned and means that the layer respectively concerned extends beyond the layer of reference, more particularly in the “xy” plane and thus laterally—perpendicular to the stacking direction. In the context of the present invention, the terms “lateral extension” or “lateral extension portion” are also used instead of the term “lateral overhang”.

The term “lateral” refers here to each direction of extension of the layer plane “xy” perpendicular to the stacking direction of the layers “z”. The term is thus in particular independent of the geometric shape of the adhesive tape in the “xy” plane, which can for example be a rectangle, as is customary for adhesive tapes (see above), but can also be a square or a circle.

The term does not address minor fluctuations in the dimensions of the individual layers in the “xy” plane that result from the die-cutting method or similar shaping methods, particularly since the dimensions of such minor material projections preclude the application of a voltage thereto in the planned manner.

The adhesive compound layers C or C and C′ can in principle be based on the same compounds as the adhesive compound layer D; the adhesive compounds of the layers C or C and C′ do not have to contain any electrolytes, but may do. Preferably, the layers C or C and C′ do not contain any electrolytes.

According to some embodiments of the three-layer composite D-T-C, described above, the adhesive compound layer C is electrically conductive.

Likewise, the adhesive compound layer C and/or adhesive compound layer C′ of the five-layer compound C-T-D-T′-C′ can also be designed to be electrically conductive.

These layers are set out further in the text below. For the sake of simplicity, the term “electrically conductive adhesive compound layer” is used at appropriate points. Depending on which one of the above embodiments, this refers to the adhesive compound layer C or the adhesive compound layers C and/or C′. In addition, for the sake of simplicity, the expression “the adhesive compound layers C or C and/or C” is used, this meaning the respective layers in the described embodiments of the adhesive tape that include at least the three-layer composite or at least the five-layer composite.

The adhesive compound layers C and C are independent of one another and may be identical or different from one another.

Preferably, the electrically conductive adhesive compound layer comprises at least one metal for this purpose, such as in particular nickel, copper or silver, preferably in the form of electrically conductive metal particles and/or metallized particles, more preferably metal particles.

Metal particles may be in any suitable forms, including dendritic metal particles.

Metallized particles are in particular and preferably glass or polymer particles metallized with at least one metal, with the result that the previously electrically non-conductive particles are made electrically conductive by the metallization.

More preferably, the electrically conductive adhesive compound layer comprises electrically conductive particles selected from the group consisting of nickel particles, copper particles and silver-coated copper particles.

In particularly preferred embodiments, the electrically conductive adhesive compound layer comprises nickel particles.

For example, the electrically conductive adhesive compound layer contains 5 to 40 parts by weight, more preferably 20 to 40 parts by weight, very preferably 25 to 35 parts by weight, of electrically conductive particles, more particularly metal particles and/or metallized particles, based on 100 parts by weight of polymers present.

The electrically conductive particles should preferably be not larger, or not significantly larger, than the respective thickness of the electrically conductive adhesive compound layer in the z direction, measured with a light microscope.

Preferably, the electrically conductive particles have an average particle size of from 1 to 10 μm, more preferably from 1 to 6 μm, even more preferably from 3 to 5 μm, such as in particular 4 μm.

The electrically conductive adhesive compound layer is in particular electrically conductive at least in the z direction.

However, it may also be electrically conductive in the xy plane. If the electrically conductive adhesive compound layer is designed to be electrically conductive only in the z direction, but not necessarily in the xy direction, a smaller amount of these materials is needed in preferred embodiments in which a metal, in particular metal particles, is added to achieve the electrical conductivity. This optimizes the adhesive compound with regard to the required conductivity, strength of adhesion, flow characteristics, and also costs.

A layer is considered to be “electrically conductive” in the context of the present invention in particular when the resistance is less than 1 ohm, as measured in the respective direction, in this case more particularly in the z direction, according to the standard MIL-DTL-83528C.

Irrespective of whether the adhesive compound layers C or C and/or C′ are of electrically conductive configuration, the statements that follow are applicable.

The adhesive compound in the adhesive compound layers C or C and/or C′ is according to preferred embodiments not a pressure-sensitive adhesive compound.

According to particularly preferred embodiments of the invention, the adhesive compound in the adhesive compound layers C or C and C′ is a pressure-sensitive adhesive compound and the adhesive compound layer C or C and C′ is thus a pressure-sensitive adhesive compound layer.

The adhesive compound layers C or C and/or C′ are according to preferred embodiments of the invention—like the adhesive compound layer D—pressure-sensitive adhesive compounds comprising at least one polyurethane.

According to preferred embodiments of the invention, the polyurethane and, where relevant, the resin used in the adhesive compound layers C or C and/or C′ are the same as in the adhesive compound layer D.

This makes it possible in particular to bond together similar substrates, here referred to as A and B.

According to further preferred embodiments of the invention, the adhesive compound used in the adhesive compound layers C or C and/or C′ is a different adhesive compound to the adhesive compound of the adhesive compound layer D.

This makes it possible to adapt the properties of the conductive layer particularly well to the substrate(s) bonded via the adhesive compound layer C or C and/or C′. Since the adhesive compound layer C or C and/or C′ preferably does not contain or have to contain any electrolyte, such as an ionic liquid, the constituents do not have to be adapted thereto.

According to preferred embodiments of the invention, the adhesive compound used in the adhesive compound layers C or C and/or C′ is a different adhesive compound to the adhesive compound in the adhesive compound layer D; the adhesive compound in the adhesive compound layers C or C and/or C′ may be heat-activatable or may be a different pressure-sensitive adhesive compound, acrylate-based for example.

The adhesive compound of the adhesive compound layer D and—depending on the embodiment—further adhesive compounds are produced by known methods and converted to layer form, in particular by spreading. This can be done by using one or more suitable solvents or else without use of solvents.

In addition, one or more drying steps may optionally be effected.

According to preferred embodiments, at least one polyurethane prepolymer composition is prepared as described, for example in solvents, in particular with the aid of catalysts, and the other substances, such as the electrolyte, optionally tackifier resin and also initiator and any further additives, are added, with adjustment if required to a desired solids content by means of (further) solvent.

The compound is then conventionally coated, in particular onto a liner or a carrier layer, and dried.

This is followed preferably by crosslinking, in particular by means of UV radiation or electron beam curing.

In the case of UV radiation, UV-A radiation is preferred in particular and for example. An irradiated dose of 1800 to 2400 mJ/cm² is preferred.

The lamination of a plurality of layers on top of one another is effected in a manner known to those skilled in the art, the layers being superposed such that this affords in particular a layer composite DTC, where T is arranged between D and C, or C′-T′-D-T-C as a double-sided adhesive tape.

The carrier layers T and T′ can be provided in various ways as already described above.

Thus it is conceivable that a) a metal foil and/or b) an electrically conductive mesh and/or d) at least one metal grid and/or e) a PET film coated with metal by vapour deposition is positioned between the respective adhesive compound layers.

In addition, it is possible for c) metal particles to undergo direct vapour deposition onto the surface of the adhesive compound layer D or C or C′.

The adhesive tape of the invention is in particular a double-sided adhesive tape in which, depending on the embodiment, two surfaces of the adhesive compound layer D (adhesive transfer tape) or a surface of the first adhesive compound layer D and a surface of the second adhesive compound layer C (three-layer composite D-T-C) or one surface each of the adhesive compound layers C and C′ (five-layer composite C-T-D-T′-C′) are available for bonding to substrates.

Advantageously, the outer, exposed surfaces of the adhesive compound layers of the adhesive tape of the invention can be provided with anti-adhesive materials, such as a release paper or a release film, also termed a liner. A liner may also be a material having anti-adhesive coating on at least one side, preferably on both sides, for example double-sidedly siliconized material. A liner, or in more general terms a temporary carrier, is not part of an adhesive tape, but merely an auxiliary for the production and/or storage thereof and/or for further processing by die-cutting. Furthermore, a liner, as opposed to a permanent carrier, is not firmly bonded to an adhesive layer but instead functions as a temporary carrier, i.e. as a carrier that can be peeled away from the adhesive layer. “Permanent carriers” are also referred to synonymously simply as “carriers” in the present application.

The thickness of the individual adhesive compound layer(s) (in the z direction) is preferably from 15 to 2000 μm, particularly preferably from 20 to 500 μm, very particularly preferably from 25 to 200 μm. However, the thickness is preferably as small as possible, for example 100 μm or less.

In the embodiments of the three-layer composite D-T-C and the five-layer composite C-T-D-T′-C′, the adhesive compound layers D and C or D and C and also D and C′ have different layer thicknesses in preferred embodiments, the thickness of the adhesive compound layer D being for example less than that of the adhesive compound layers C or C and C′.

In further preferred embodiments, the layers D and C or D, C, and C′ have the same layer thickness.

If the layer thickness of layer D is too high, this may become uneconomically costly on account of the electrolytes present therein.

To boost the anchoring of the adhesive compound layer(s) on a carrier layer, if desired, the carrier layer can be chemically and/or physically pretreated, in particular physically pretreated.

Corona, plasma or flame pretreatment is conceivable. Corona surface treatment, including for metallized films, is known to the skilled person and is described for example in EP 355 622 A2.

In the following, preferred embodiments of the invention are elucidated and described more particularly with reference to the accompanying figures. In the figures:

FIG. 1 shows a simplified schematic cross-sectional representation through a double-sided adhesive tape of the invention in a preferred embodiment; and

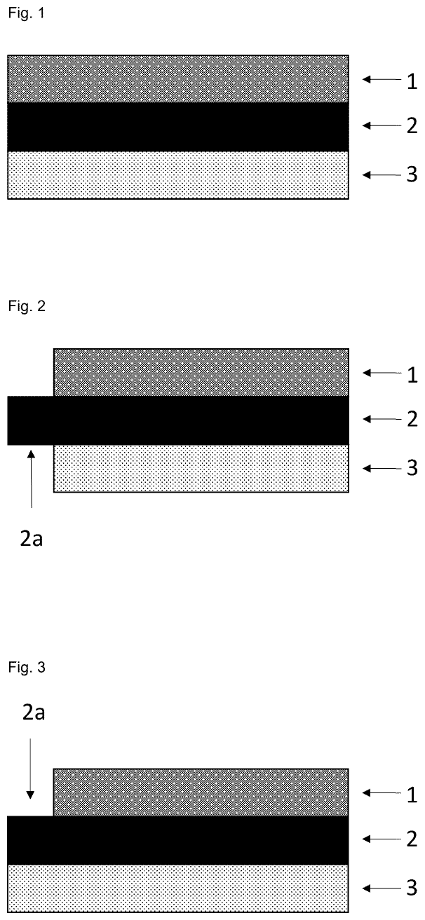

FIG. 2 shows a simplified schematic cross-sectional representation through a double-sided adhesive tape of the invention in a preferred embodiment; and

FIG. 3 shows a simplified schematic cross-sectional representation through a double-sided adhesive tape of the invention in a preferred embodiment; and

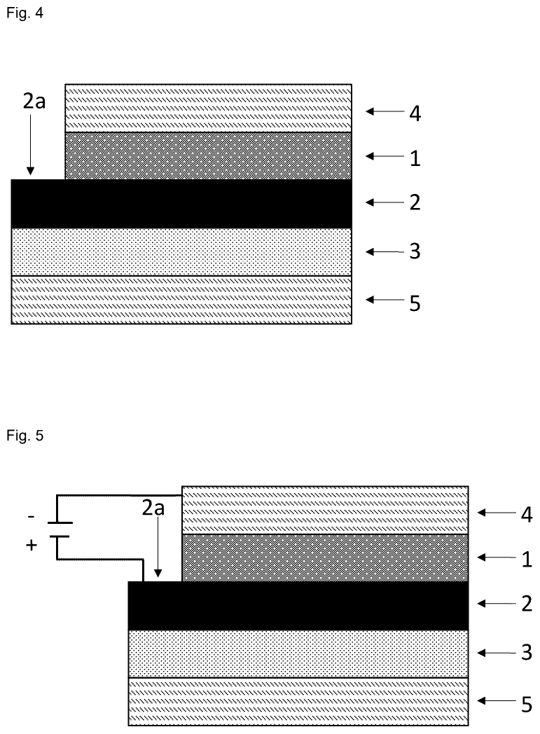

FIG. 4 shows a simplified schematic cross-sectional representation through a bonded assembly of the invention in a preferred embodiment; and

FIG. 5 shows a simplified schematic cross-sectional representation through a bonded assembly according to the invention to which a voltage is being applied, in a preferred embodiment; and

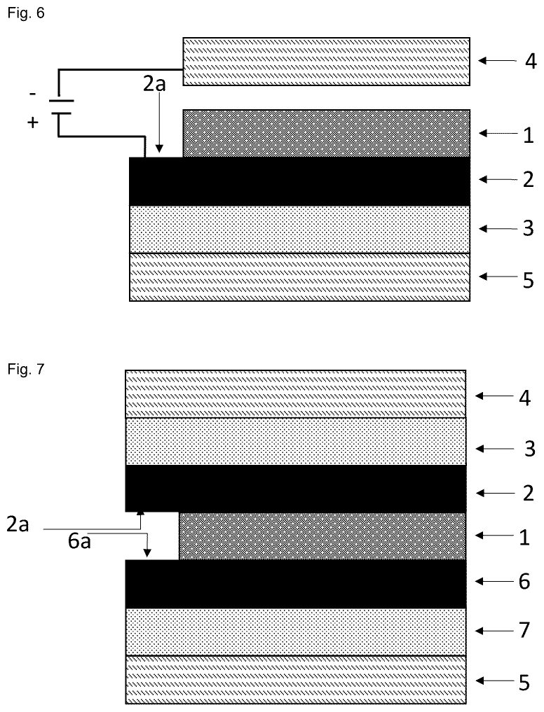

FIG. 6 shows a simplified schematic cross-sectional representation through a bonded assembly according to the invention after a voltage has been applied and an adhesive split has occurred as a result; and

FIG. 7 shows a simplified schematic cross-sectional representation through a bonded assembly of the invention in a preferred embodiment; and

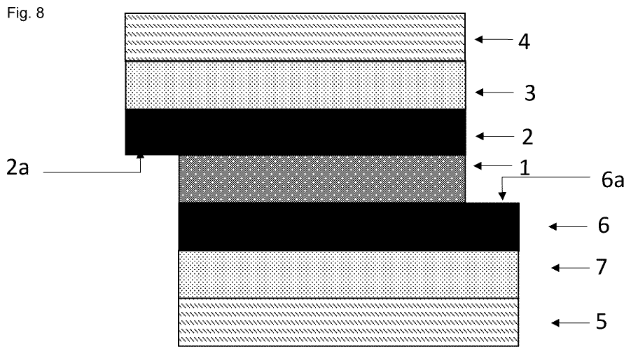

FIG. 8 shows a simplified schematic cross-sectional representation through a bonded assembly of the invention in a preferred embodiment.

As can be seen in FIG. 1, the adhesive compound layer D 1 is attached via one of its surfaces to the carrier layer T 2. The second adhesive compound layer C 3 is arranged on the surface of the carrier layer T on the opposite side to the layer D.

As can also be seen in FIG. 1, the layer composite represents a double-sided adhesive tape in which a surface of the adhesive compound layer D and a surface of the second adhesive compound layer C are each available for bonding.

FIG. 2 shows a preferred embodiment of the invention. In this case, the electrically conductive carrier layer T 2 protrudes laterally over the adhesive compound layer D 1 and over the second adhesive compound layer C 3 in at least one direction of extension of the layer plane, such that the electrically conductive carrier layer T 2 includes an overhang having at least one free surface 2 a.

FIG. 3 shows a further preferred embodiment of the invention. In this case, the electrically conductive carrier layer T 2 protrudes laterally over the adhesive compound layer D 1 in at least one direction of extension of the layer plane, such that the electrically conductive carrier layer T 2 includes an overhang having a free surface 2 a. In FIG. 3, the adhesive compound layer C 3 is formed such that it likewise includes an overhang relative to the layer D 1. The carrier layer T 2 is in particular a PET film coated with tin on one side, the tin-metallized side being attached to the layer D 1.

FIG. 4 shows a schematic diagram of the bonded assembly according to the invention in a preferred embodiment. As can be seen from FIG. 4, the adhesive tape is arranged over the adhesive compound layer D 1 on a surface of the first substrate A 4, the first substrate being electrically conductive.

In addition, the adhesive tape is arranged over the second adhesive compound layer C 3 on a surface of a second substrate B 5.

FIG. 4 likewise shows by way of example the lateral protrusion of the electrically conductive carrier layer T 2 over the adhesive compound layer D 1 in at least one direction of extension of the layer plane, such that the electrically conductive carrier layer T includes an overhang having a free surface 2 a.

It is now possible to apply a voltage via this free surface 2a, as shown in the schematic representation in FIG. 5.

The applying of the voltage results in significant lowering of the adhesion of the adhesive compound layer D 1 to the substrate A 4 and in the debonding of these layers from one another, as apparent from the schematic diagram in FIG. 6.

In FIG. 7, a further schematic representation of the bonded assembly of the invention is shown in a preferred embodiment. As can be seen from FIG. 7, the adhesive tape is arranged over the adhesive compound layer C 3 on a surface of the first substrate A 4.

In addition, the adhesive tape is arranged over the third adhesive compound layer C′ 7 on a surface of a second substrate B 5.

Present between the layers C 3 and C′ 7 are the electrically detachable adhesive compound layer D 1 and two electrically conductive carrier layers T 2 and T′ 6, the layer D 1 being arranged between the carrier layers.

FIG. 7 likewise shows by way of example the lateral protrusion of the electrically conductive carrier layer T 2 and of the electrically conductive carrier layer T′ 6 over the adhesive compound layer D 1 in each case in at least one direction of extension of the layer plane, such that the electrically conductive carrier layer T includes an overhang having a free surface 2 a and the electrically conductive carrier layer T′ includes an overhang having a free surface 6a.

In FIG. 8, a further schematic representation of the bonded assembly of the invention is shown in a preferred embodiment similar to the representation in FIG. 7. In contrast to FIG. 7, the overhangs of the electrically conductive carrier layer T 2 and the electrically conductive carrier layer T′ 6 are however in different directions, with the result that the resulting free surfaces of these layers 2a and 6a are spatially separated.

It is now possible to apply a voltage via these free surfaces 2a and 6a in an analogous manner to FIG. 5. In contrast to the embodiment shown in FIG. 5, the voltage can be applied to surfaces 2a and 6a, which means there is no need for either of substrates A and B to be electrically conductive.

The applying of the voltage results in significant lowering of the adhesion of the adhesive compound layer D 1 to the carrier layers T 2 and/or T′ 6, and these layers debond from one another. More particularly, detachment occurs at the layer to which the negative pole is applied.

The application of the voltage is simplified in the case of the spatially separated surfaces 2a and 6a as per FIG. 8.

The representations in FIGS. 1 to 8 are schematic representations as shown. In particular, the layer thicknesses of the individual layers D, T, and C may differ from one another. Moreover, the substrates A and B are represented as further layers only schematically. These can of course have any other spatial geometry.

A number of examples are described hereinbelow for further illustration of the invention. The examples marked with “I” are examples of adhesive compounds of the invention, whereas the examples marked with “C” are comparative examples.

TABLE 1
Raw materials used

| | | Manufacturer/ |
|---|---|---|
| Trade name | Chemical name/description | supplier |
| STEPANPOL PH-56 | Aromatic polyester polyol | Stepan Company |
| | (Mw around 2000 g/mol) | |
| Krasol ® LBH 2000 | Hydroxyl-terminated | Cray Valley |
| | polybutadiene, polybutadiene | |
| | polyol (Mw around 2000 | |
| | g/mol) | |
| GMMA | Glycerol monomethacrylate | abcr GmbH |
| | (CAS: 5919-74-4) | |
| IPDI | Isophorone diisocyanate | Sigma Aldrich |
| | (CAS: 4098-71-9) | |
| Coscat ® 83 | Catalyst, bismuth | Vertellus |
| | trisneodecanoate | |
| | (+neodecanoic acid); | |
| | (CAS: 34364-26-6/ | |
| | 26896-20-8) | |
| Methyl ethyl ketone | Solvent (CAS: 78-93-3) | Sigma Aldrich |
| (MEK) | | |
| BMIM-PF₆ | 1-Butyl-3-methylimidazolium | Sigma Aldrich |
| | hexafluorophosphate (CAS: | |
| | 174501-64-5) | |
| EMIM-TFSI | 1-Ethyl-3-methylimidazolium | Sigma Aldrich |
| | bis(trifluoromethyl- | |
| | sulfonyl)imide (CAS: | |
| | 174899-82-2) | |
| AMIM-TFSI | 1-Allyl-3-methylimidazolium | Sigma Aldrich |
| | bis(trifluoromethyl- | |
| | sulfonyl)imide (CAS: | |
| | 655249-87-9) | |
| EMIM-OTf | 1-Ethyl-3-methylimidazolium | Sigma Aldrich |
| | triflate (CAS: 145022-44-2) | |
| Novares TK 100 Solid | HC-based resin | Rain Carbon |
| | | Germany GmbH |
| 2,2-Dimethoxy-2- | Photoinitiator (CAS: | Sigma Aldrich |
| phenylacetophenone | 24650-42-8) | |
| (DMPA) | | |

TABLE 2
Abbreviations

| | |
|---|---|
| IPA | isopropyl alcohol |
| MEK | methyl ethyl ketone |
| NCO | isocyanate |
| OH | hydroxy |
| PET | polyethylene |
| | terephthalate |
| PU | polyurethane |
| rpm | revolutions per minute |

The compositions which were investigated for their electrical detachability are shown in Tables 3 to 6. The amounts of the constituents are each given in % by weight, where the sum totals of all constituents of an illustrative composition result in 100% by weight.

The compositions in Table 3 were produced as follows:

1) Production of a mixture containing a first PU prepolymer 1 (example for polyurethane prepolymer a1):
1a) Mixing of the diols (57.96% by weight of STEPANPOL PH-56 and 0.51% by weight of GMMA) in a glass with 35% by weight of MEK solvent
1b) Stirring until homogeneous mass is reached, then addition of 6.43% by weight of the diisocyanate (IPDI); NCO:OH ratio 0.9
1c) Stirring for 5 min, then transfer to reactor (under nitrogen)
1d) Addition of 0.10% by weight of Coscat 83 catalyst
1e) Stirring for 24 h at 200 rpm and 60° C.

The quantities in % by weight are based on the total weight of the mixture produced in this step 1).

2) Production of a mixture containing a second PU prepolymer 2 (example for polyurethane prepolymer a2)
2a) Mixing of the diols (63.01% by weight of Krasol LBH-2000 and 0.51% by weight of GMMA) in a glass with 30% by weight of MEK solvent
2b) Stirring until homogeneous mass is reached, then adding 6.37% by weight of the diisocyanate (IPDI); NCO:OH ratio 0.9
2c) Stirring for 5 min, then transfer to reactor (under nitrogen)
2d) Addition of 0.11% by weight of Coscat 83 catalyst
2e) Stirring for 24 h at 200 rpm and 60° C.

The quantities in % by weight are based on the total weight of the mixture produced in this step 2).

3) Production of the blend
3a) Mixing of the mixture from step 1 (prepolymer 1) with the mixture from step 2) (prepolymer 2) in a glass in a ratio of 80/20 with respect to the solid content
3b) Addition of the respective ionic liquid in the amount specified in Table 3
3c) Addition of DMPA in the specified amount
3d) Stirring until the mass was homogeneous.

4) Crosslinking
4a) Coating-out of the mass after step 3d) onto a silicone release-coated PET liner (50 μm layer thickness of the coated-out mass)
4b) Drying for 15 min at 80° C., causing the MEK solvent to evaporate
4c) Enveloping with siliconized PET film
4d) Crosslinking under UV light (2000 mJ/cm², in the UV-A region).

The crosslinked pressure-sensitive adhesive compound layers obtained after step 4d) were investigated for their peel adhesion and their electrical detachability.

For this purpose, the layers were each laminated onto a 23 μm thick, tin-coated PET film. The tin coating on the PET film was in contact with the respective adhesive compound to be investigated for electrical detachability.

In addition, the chemical resistance was also determined by measurement of the peel adhesion, as described below. For this purpose, the crosslinked pressure-sensitive adhesive compound layers obtained after step 4d) were laminated onto a 23 μm thick PET film, but without tin coating.

The compositions in Table 4 were produced in a similar manner as described for Table 3, additionally adding the resin in the specified amount between step 3a) and 3b).

The masses obtained were also homogenized and coated out and crosslinked as indicated above.

The compositions in Table 5 were produced in a similar manner as described for Table 3, with step 2) (preparation of the prepolymer 2) being omitted, since these compositions contain only one polyurethane prepolymer.

The compositions in Table 6 were produced in a similar manner as described for Table 3, with step 1) (preparation of the prepolymer 1) being omitted, since these compositions contain only one polyurethane prepolymer.

The respective substances in the examples in Tables 5 and 6 were mixed with each other in the amounts indicated.

The masses obtained were also homogenized and coated out and crosslinked as indicated above.

The adhesive tapes were tested in respect of their electrical detachability based on peel adhesion on steel; the peel adhesion was tested before application of a voltage, and further test specimens had a voltage of 9 V applied for 60 seconds before determination of the peel adhesion.

The voltage here was applied between the steel substrate and the tin-coated PET film, with the negative pole applied to the steel substrate and the positive pole to the tin foil.

Further details regarding the test methods are given in the “Test methods” section below.

The results are likewise collated in Tables 3 to 6. For the examples in which no ionic liquid is contained and thus there is no electrical detachability even by application of a voltage, further investigations after storage under various conditions were omitted and the corresponding values were thus not determined (n.d.). Furthermore, for reasons of efficiency, the storage tests (peel adhesion before and after application of a voltage for samples stored under the specified conditions) were carried out only for selected examples according to the invention. In the other examples, the corresponding values were then also not determined.

TABLE 3
Compositions of PU prepolymer blend without resin and measurement results

| Constituents | C1 | I1 | I2 | I3 | I4 | I5 | I6 | I7 | I8 | I9 |
|---|---|---|---|---|---|---|---|---|---|---|
| PH 56 | 71.2 | 67.9 | 66.6 | 64.7 | 69.8 | 68.7 | 67.9 | 66.6 | 66.6 | 66.6 |
| GMMA | 0.8 | 0.7 | 0.7 | 0.7 | 0.8 | 0.8 | 0.7 | 0.7 | 0.7 | 0.7 |
| IPDI | 9.7 | 9.2 | 9.1 | 8.8 | 9.5 | 9.4 | 9.2 | 9.1 | 9.1 | 9.1 |
| CosCat 83 | 0.1 | 0.1 | 0.1 | 0.1 | 0.1 | 0.1 | 0.1 | 0.1 | 0.1 | 0.1 |
| DMPA | 0.2 | 0.2 | 0.2 | 0.2 | 0.2 | 0.2 | 0.2 | 0.2 | 0.2 | 0.2 |
| Krasol LBH-2000 | 18.0 | 17.1 | 16.8 | 16.3 | 17.6 | 17.4 | 17.1 | 16.8 | 16.8 | 16.8 |
| BMIM-PF₆ | 0.0 | 4.8 | 6.5 | 9.1 | 0.0 | 0.0 | 0.0 | 0.0 | 0.0 | 0.0 |
| EMIM-TFSI | 0.0 | 0.0 | 0.0 | 0.0 | 2.0 | 3.4 | 4.8 | 6.5 | 0.0 | 0.0 |
| EMIM-OTI | 0.0 | 0.0 | 0.0 | 0.0 | 0.0 | 0.0 | 0.0 | 0.0 | 6.5 | 0.0 |
| AMIM-TFSI | 0.0 | 0.0 | 0.0 | 0.0 | 0.0 | 0.0 | 0.0 | 0.0 | 0.0 | 6.5 |
| Peel adhesion [N/cm] initial | 2.2 | 3.2 | 2.7 | 3.0 | 3.0 | 2.7 | 2.5 | 2.3 | 3.3 | 1.9 |
| Peel adhesion 3T, 23° C., 50% RH [N/cm] | n.d. | n.d. | 4.6 | n.d. | n.d. | n.d. | 5.0 | 4.3 | n.d | n.d. |
| Peel adhesion 3T, 65° C., 90% RH [N/cm] | n.d. | n.d. | 4.4 | n.d. | n.d. | n.d. | 7.4 | n.d. | n.d. | n.d. |
| Peel adhesion +9 V, 60 s [N/cm] | 2.4 | 0.9 | <0.1 | <0.1 | <0.1 | <0.1 | <0.1 | <0.1 | 1.1 | <0.1 |
| Peel adhesion 3T, 23° C., 50% RH +9 V, | n.d. | n.d. | 0.8 | n.d. | n.d. | n.d. | 1.2 | <0.1 | n.d. | n.d. |
| 60 s [N/cm] | | | | | | | | | | |
| Peel adhesion 3T, 65° C., 90% RH, +9 V, | n.d. | n.d. | 0.3 | n.d. | n.d. | n.d. | <0.1 | n.d. | n.d. | n.d. |
| 60 s [N/cm] | | | | | | | | | | |
| Chemical resistance: peel adhesion after IPA/H₂O [N/cm] | A | A | A | A | A | A | A | A | A | A |

TABLE 4
Compositions of PU prepolymer blend
with resin and measurement results

| Constituents | C2 | I10 | I11 |
|---|---|---|---|
| PH 56 | 68.4 | 64.1 | 64.1 |
| GMMA | 0.8 | 0.7 | 0.7 |
| IPDI | 9.3 | 8.8 | 8.8 |
| CosCat 83 | 0.1 | 0.1 | 0.1 |
| DMPA | 0.2 | 0.2 | 0.2 |
| Krasol LBH-2000 | 17.3 | 16.2 | 16.2 |
| Novares TK-100 | 3.8 | 3.6 | 3.6 |
| BMIM-PF₆ | 0.0 | 6.3 | 0.0 |
| EMIM-TFSI | 0.0 | 0.0 | 6.3 |
| Peel adhesion [N/cm] initial | 2.7 | 3.8 | 3.5 |
| Peel adhesion + 9 V, 60 s [N/cm] | 2.6 | <0.1 | <0.1 |
| Peel adhesion 3T, 23° C., 50% RH | n.d. | 4.0 | 4.2 |
| [N/cm] | | | |
| Peel adhesion 3T, 23° C., 50% RH + | n.d. | <0.1 | 0.4 |
| 9 V, 60 s [N/cm] | | | |
| Chemical resistance: peel adhesion | A | A | A |
| after IPA/H₂O [N/cm] | | | |

TABLE 5
Composition with only one polyurethane
prepolymer a1) and measurement results

| Constituents | C3 | I12 | I13 |
|---|---|---|---|
| PH 56 | 88.94 | 83.13 | 83.13 |
| GMMA | 0.79 | 0.74 | 0.74 |
| IPDI | 9.87 | 9.22 | 9.22 |
| CosCat 83 | 0.15 | 0.14 | 0.14 |
| DMPA | 0.25 | 0.23 | 0.23 |
| BMIM-PF₆ | 0.0 | 6.54 | 0.0 |
| EMIM-TFSI | 0.0 | 0.0 | 6.54 |
| Peel adhesion [N/cm] initial | 1.9 | 3.0 | 2.4 |
| Peel adhesion + 9 V, 60 s [N/cm] | 1.8 | <0.1 | <0.1 |
| Peel adhesion 3T, 23° C., 50% RH | n.d. | 5.8 | 4.5 |
| [N/cm] | | | |
| Peel adhesion 3T, 23° C., 50% RH + | n.d. | <0.1 | <0.1 |
| 9 V, 60 s [N/cm] | | | |

TABLE 6
Composition with only one polyurethane prepolymer
a2) without resin and measurement results

| Constituents | C4 | C5 | C6 |
|---|---|---|---|
| GMMA | 0.7 | 0.7 | 0.7 |
| IPDI | 9.1 | 8.5 | 8.5 |
| CosCat 83 | 0.1 | 0.1 | 0.1 |
| DMPA | 0.3 | 0.3 | 0.3 |
| Krasol LBH-2000 | 89.8 | 83.9 | 83.9 |
| BMIM-PF₆ | 0.0 | 6.5 | 0.0 |
| EMIM-TFSI | 0.0 | 0.0 | 6.5 |
| Peel adhesion [N/cm] initial | 2.1 | 2.0 | 2.4 |
| Peel adhesion + 9 V, 60 s [N/cm] | 2.2 | 2.3 | 2.4 |
| Peel adhesion 3T, 23° C., 50% RH | n.d. | 3.7 | 4.9 |
| [N/cm] | | | |
| Peel adhesion 3T, 23° C., 50% RH + | n.d. | 3.5 | 4.1 |
| 9 V, 60 s [N/cm] | | | |

TABLE 7
Ionic conductivity of selected compositions

| | Ionic conductivity |
|---|---|
| Composition | σ ± s in μS/m |
| I1 | 1.82 ± 0.02 |
| I2 | 2.47 ± 0.09 |
| I7 | 6.24 ± 0.14 |
| I8 | 0.235 ± 0.006 |
| I10 | 1.98 ± 0.07 |
| I12 | 2.39 ± 0.01 |
| I13 | 3.77 ± 0.03 |

As can be seen from Tables 3 to 6, success was achieved, with the examples according to the invention comprising a) at least one polyurethane prepared by crosslinking at least one polyurethane prepolymer based on at least one polar polyol which is selected from the group consisting of polyester polyols, polycarbonate polyols and polyether polyols, and b) at least one electrolyte, in particular at least one ionic liquid, in significantly reducing the peel adhesion by applying a voltage, so that the bonded substrates can be debonded from each other without damage and with little or almost no force applied. At the same time, the corresponding pressure-sensitive adhesive compounds or pressure-sensitive adhesive tapes and the bonded assemblies produced from them are stable in storage under standard conditions but also under hot and humid conditions (65° C., 90% RH): The peel adhesion forces and the electrical detachability are not negatively affected by the storage. At the same time, the examples according to the invention have a high chemical resistance.

### Test Methods

Unless stated otherwise, all measurements are conducted at 23° C. and 50% relative humidity.

The mechanical and adhesion data were determined as follows:

### Molar Mass (GPC)

The reported values for the number-average or weight-average molar mass (Mn or Mw, respectively) in this document refer to the known determination by gel permeation chromatography (GPC). The determination is carried out on a clear-filtered 100 μl sample (sample concentration 4 g/l). The eluent employed is tetrahydrofuran containing 0.1% by volume of trifluoroacetic acid. The measurement is performed at 25° C.

The precolumn used is a type PSS-SDV column, 5 μm, 10³ Å, 8.0 mm*50 mm (values here and hereinafter in the following sequence: type, particle size, porosity, internal diameter*length; 1 Å=10⁻¹⁰ m). The separation employs a combination of PSS SDV-type columns, 5 μm, 10³ Å and also 10⁵ Å and 10⁶ Å, in each case 8.0 mm*300 mm (columns from Polymer Standards Service; detection using a Shodex RI71 differential refractometer). The flow rate is 1.0 ml per minute. The calibration is carried out using the commercially available ReadyCal-Kit Poly(styrene) high from PSS Polymer Standards Service GmbH, Mainz, and so the data are reported in polystyrene mass equivalents.

### Peel Adhesion, Steel

To test the peel adhesion on steel of the layer to be investigated for electrical detachability: A 20 mm wide strip of the adhesive tape comprising the adhesive compound to be investigated for electrical detachability and the 23 μm thick, tin-coated PET film was applied to a steel plate which was previously washed twice with acetone. The adhesive strip is pressed onto the substrate by rolling down back and forth five times using a 4 kg roller. The adhesive tape is removed from the substrate immediately (initially) at a speed of 300 mm/min and at an angle of 180°. All measurements are carried out at room temperature.

In addition, samples are stored for 3 days (3T) at 23° C. and 50% RH, or for 3 days at 65° C. and 90% RH, and then the adhesive tape is removed from the substrate at a speed of 300 mm/min and at an angle of 180°.

### Electrical Detachability

To measure the strength of adhesion after applying a voltage, the adhesive tape is bonded to the steel plate as described above. A DC voltage of 9 V is applied, with the negative pole positioned on the steel plate and the positive pole positioned on the tin-coated film.

After 60 s, the voltage is switched off and the sample is immediately clamped into the measuring apparatus and the strength of adhesion measured.

The adhesion times or storage times specified in the respective tables are also applied before application of the voltage.

### Chemical Resistance

To assess the chemical resistance, the peel adhesion on ASTM steel is compared before and after treatment with a mixture of isopropanol/water 70/30 (fractions by weight).

A 0.5 cm wide strip of the pressure-sensitive adhesive tape is bonded to an ASTM test plate by rolling back and forth five times using a 4 kg roller. The bonds obtained in this way are stored for 24 h under standard conditions (air, 23° C., 50% relative humidity) and then stored in a sealed box with the test chemicals so that they are completely covered by these chemicals.

The box is stored for 72 h in an oven thermostated at 60° C.

The boxes are removed from the oven after the storage time, and the sample specimens are carefully cleaned with a cloth and conditioned for 2 h under standard conditions.

For the determination of the peel adhesion (under standard conditions—air, 23° C., 50% relative humidity), the test plate was clamped in and the self-adhesive strip was removed via its free end using a tensile testing machine at a peel angle of 180° at a speed of 300 mm/min. The force required for this is determined with a tensile tester. The measurement results are averaged over three measurements and normalized to the width of the strip in N/cm. Based on these results, the chemical resistance was categorized as follows, with the initial peel adhesion described above serving as reference.

TABLE 7
Evaluation of chemical resistance

| Evaluation of | |
|---|---|
| chemical | |
| resistance | Observation |
| A | Adhesive tape after chemical treatment showed a peel |
| | adhesion of >60% compared to the reference |
| B | Adhesive tape after chemical treatment showed a peel |
| | adhesion of >30% compared to the reference |
| C | Adhesive tape debonded from the steel plate |

### Thickness

The thickness of an adhesive compound layer can be determined by determining the thickness of a section, defined in terms of its length and width, of such an adhesive compound layer applied to a liner, minus the (known or separately determinable) thickness of a section of the same dimensions of the liner used. The thickness of the adhesive compound layer can be determined with accuracies of less than 1 μm deviation using commercially available thickness gauges (sensor test devices). If variances in thickness are detected, the mean value of measurements at not fewer than three representative sites is reported; in other words, there is in particular no measurement at creases, folds, nibs and the like.

As already described above for the thickness of an adhesive compound layer, it is also possible to analogously determine the thickness of an adhesive tape (adhesive strip) or of a carrier with accuracies of less than 1 μm variance using commercially available thickness gauges (sensor test devices). If variances in thickness are detected, the mean value of measurements at not fewer than three representative sites is reported; in other words, there is in particular no measurement at creases, folds, nibs and the like.

### Ionic Conductivity

The ionic conductivity of the pressure-sensitive adhesive compound layers was determined by potentiostatic electrochemical impedance spectroscopy (PEIS). The measurements were made with a BioLogic VMP-300 potentiostat and an AC voltage with an amplitude of 10 mV in the frequency range from 1 MHz to 100 mHz. For the measurement, similarly to the peel adhesion measurement, a 20 mm wide strip of the adhesive tape comprising the adhesive compound under investigation and a 23 μm thick, tin-coated PET film was applied to a steel plate which was previously washed twice with acetone and laterally insulated. Samples were stored prior to measurement typically at 23° C. and 55% relative humidity and measurements were performed at 23° C. The working electrode was attached to the tin-coated PET film and the counter-electrode to the steel plate. The effective sample area was 1 cm×4 cm (4 cm²). After the measurement, the ionic conductivity (σ) was calculated according to the equation σ=L/(R*A), where L is the adhesive layer thickness (in this case always 100 μm), A is the sample cross-sectional area (4 cm²) and R=the bulk resistance R2 (in Ω).

### LIST OF REFERENCE NUMERALS

1 adhesive compound layer D
2 electrically conductive carrier layer T
2a free face of electrically conductive carrier layer T
3 second adhesive compound layer C
4 first substrate A
5 second substrate B
6 second electrically conductive carrier layer T′
6a free face of electrically conductive carrier layer T′
7 third adhesive compound layer C′

1. Pressure-sensitive adhesive compound containing
a) at least one crosslinked polyurethane prepared by crosslinking one or more polyurethane prepolymers, at least one of the polyurethane prepolymers being based on at least one polyol which is selected from the group consisting of polyester polyols, polycarbonate polyols and polyether polyols; and
b) at least one electrolyte, the electrolyte being selected from the group consisting of ionic liquids and metal salts.

2. Pressure-sensitive adhesive compound according to claim 1, wherein
the anion of the ionic liquid is selected from the group consisting of
hexafluorophosphate (PF₆⁻), bis(trifluoromethylsulfonyl)imide (CF₃SO₂)₂N⁻, TFSI), acetate (CH₃COO⁻), tetrafluoroborate (BF₄⁻), octanoate, tosylate (OTs), trifluoromethanesulfonate (CF₃SO₃⁻, OTf, triflate), benzoate, bis(fluorosulfonyl)imide ((FSO₂)₂N⁻, FSI), dicyanamide (N(CN)₂⁻), ethyl sulfate, hexyl sulfate, perchlorate, methanesulfonate (CH₃SO₃⁻), methyl sulfate (CH₃O—SO₃⁻), acrylate, propionate, methyl carbonate, methyl phosphonate (CH₄O₃P⁻), thiocyanate (SCN⁻), dibutyl phosphate, diethyl phosphate, dodecanoate, bromide (Br⁻), fluoride (F⁻), chloride (Cl⁻), iodide (1), tetrachloroaluminate (AlCl₄⁻), tetrachloroferrate (FeCl₄⁻), Al₂Cl₇⁻, NO₃, CF₃COO⁻, CF₃CO₃⁻, (CF₃SO₂)₃C⁻, AsFe⁻, SbF⁻, CF₃(CF₂)₃SO₃⁻, (CF₃CF₂SO₂)₂N⁻ and CF₃CF₂CF₂COO⁻ and preferably selected from the group consisting of hexafluorophosphate (PF₆⁻), bis(trifluoromethylsulfonyl)imide (CF₃SO₂)₂N⁻, TFSI), acetate (CH₃COO⁻), tetrafluoroborate (BF₄⁻), octanoate, tosylate (OTs), trifluoromethanesulfonate (CF₃SO₃⁻, OTf, triflate), benzoate, bis(fluorosulfonyl)imide ((FSO₂)₂N⁻, FSI) and dicyanamide (N(CN)₂⁻) and/or the cation of the ionic liquid is selected from the group consisting of imidazolium-based cations, pyridinium-based cations, pyrrolidinium-based cations, ammonium-based cations, phosphonium-based cations, oxazolium-based cations, guanidinium-based cations and thiazolium-based cations, and particularly preferably selected from the group consisting of imidazolium-based cations, the cation being particularly preferably selected from the group consisting of 1-ethyl-3-methylimidazolium, 1-butyl-3-methylimidazolium and 1-allyl-3-methylimidazolium.

3. Pressure-sensitive adhesive compound according to claim 1, wherein the electrolyte is selected from the group consisting of the ionic liquids 1-ethyl-3-methylimidazolium bis(trifluoromethylsulfonyl)imide (EMIM-TFSI), 1-allyl-3-methylimidazolium bis(trifluoromethylsulfonyl)imide (AMIM-TFSI), 1-ethyl-3-methylimidazolium triflate (EMIM-OTf) and 1-butyl-3-methylimidazolium hexafluorophosphate (BMIM-PF₆).

4. Pressure-sensitive adhesive compound according to claim 1, wherein it contains 1.0% to 15% by weight or 2.5% to 11% by weight, of electrolytes, which are optionally ionic liquids, based on the total weight of the pressure-sensitive adhesive compound.

5. Pressure-sensitive adhesive compound according to claim 1, wherein the at least one crosslinked polyurethane a) comprises at least one polyurethane which has no free isocyanate groups.

6. Pressure-sensitive adhesive compound according to claim 1, wherein the at least one crosslinked polyurethane a) is prepared by crosslinking a blend of at least two different polyurethane prepolymers a1) and a2), wherein the polyurethane prepolymers a1) and a2) differ from each other with regard to the composition of the polymer chain, wherein at least one of the polyurethane prepolymers is based on a polyester polyol and/or a polycarbonate polyol.

7. Pressure-sensitive adhesive compound according to claim 6, wherein the first polyurethane prepolymer a1) is based on a polyester polyol and/or a polycarbonate polyol and the second polyurethane prepolymer a2) is based on a hydroxy-terminated aliphatic polymer, which is optionally a polybutadiene polyol, and/or a polyfarnesene polyol and/or a fatty acid-based polyester polyol.

8. Pressure-sensitive adhesive compound according to claim 1, wherein the one or more polyurethane prepolymers for the preparation of the crosslinked polyurethane a) are based in each case on the polyaddition of a starting composition which contains at least one diol compound A, wherein the diol compound A has per molecule at least one C—C double bond protruding from the chain extending between the OH groups, wherein the fraction of diol compounds A in the starting composition is 15% by weight or less, 10% by weight or less, or 5% by weight or less, based on the total weight of the starting composition in question, and wherein the crosslinking of the polyurethane prepolymers for the preparation of the crosslinked polyurethane a) takes place via these protruding C—C double bonds.

9. Pressure-sensitive adhesive compound according to claim 8, wherein the at least one diol compound A is selected from the group consisting of (meth)acrylates.

10. Pressure-sensitive adhesive compound according to claim 1, wherein the crosslinking takes place by means of UV radiation or by means of electron beam curing.

11. Pressure-sensitive adhesive compound according to claim 1, wherein it contains at least one resin.

12. Adhesive tape comprising at least one pressure-sensitive adhesive compound layer D of a pressure-sensitive adhesive compound according to claim 1.

13. Adhesive tape according to claim 12, wherein the adhesive tape is an adhesive transfer tape comprising the pressure-sensitive adhesive compound layer D.

14. Adhesive tape according to claim 12, further comprising at least the following layers:
at least one electrically conductive carrier layer T and
optionally a second adhesive compound layer C, which is arranged on the side of the carrier layer T that is opposite the adhesive compound layer D.

15. Adhesive tape according to claim 12, further comprising at least the following layers:
a second adhesive compound layer C; and
at least a first electrically conductive carrier layer T that is arranged between layers D and C; and
at least one second electrically conductive carrier layer T′ that is arranged on the surface of the adhesive compound layer D on the opposite side to the first electrically conductive carrier layer T; and
a third adhesive compound layer C′ that is arranged on the surface of the second carrier layer T′ on the opposite side to the first adhesive compound layer D.

16. Bonded assembly comprising at least layers as follows:
a first substrate A; and
a second substrate B; and
an adhesive tape according to claim 12, which is arranged between the substrate A and the substrate B and bonds the substrates A and B to each other, wherein either the substrate A and the substrate B, or at least one of the substrates and the adhesive tape, or the adhesive tape, are/is of electrically conductive configuration at two different points.

17. Method for electrically debonding the assembly according to claim 16, comprising at least method steps as follows:
i.) applying a voltage at two different electrically conductive points of the assembly, the voltage optionally being 1 to 50 V or 2 to 50 V.

18. Method of bonding substrate surfaces which comprises applying a pressure-sensitive adhesive compound according to claim 1 to at least one substrate used in electronic devices, motor vehicles, medical devices, dental devices, in the DIY sector and/or in the household.

19. The pressure-sensitive adhesive compound according to claim 1, wherein the at least one electrolyte comprise ionic liquids.

20. The pressure-sensitive adhesive compound according to claim 2, wherein the anion of the ionic liquid is selected from the group consisting of hexafluorophosphate (PF₆⁻), bis(trifluoromethylsulfonyl)imide (CF₃SO₂)₂N⁻, TFSI), acetate (CH₃COO⁻), tetrafluoroborate (BF₄⁻), octanoate, tosylate (OTs), trifluoromethanesulfonate (CF₃SO₃⁻, OTf, triflate), benzoate, bis(fluorosulfonyl)imide ((FSO₂)₂N⁻, FSI) and dicyanamide (N(CN)₂⁻), and/or
the cation of the ionic liquid is selected from the group consisting of imidazolium-based cations, or is selected from the group consisting of 1-ethyl-3-methylimidazolium, 1-butyl-3-methylimidazolium and 1-allyl-3-methylimidazolium.
